(19) United States
(12) Patent Application Publication
(10) Pub. No.: US 2016/0373575 A1
(43) Pub. Date: Dec. 22, 2016

(54) Telecommunications and Network Traffic Control System

(71) Applicant: SipNav, LLC, Las Vegas, NV (US)

(72) Inventors: Scott Presta, Trabuco Canyon, CA (US); John Osterle, San Diego, CA (US); Kristofer Droge, San Diego, CA (US)

(73) Assignee: SipNav, LLC, Las Vegas, NV (US)

(21) Appl. No.: 14/744,025

(22) Filed: Jun. 19, 2015

(51) Int. Cl. H04M 3/36; H04L 12/853; H04M 15/00; H04L 12/841

(52) U.S. Cl. CPC H04M 3/367; H04L 47/28; H04L 47/2416; H04M 15/8044

(57) ABSTRACT

A telecommunication and network traffic throttle and control system including one or more processors coupled to a communications network. The system is configured to monitor, control, and throttle network traffic to limit and block unwanted and harmful traffic to optimize performance of and protect telecommunications and network infrastructure. Received routing requests are parsed for source automatic number identifications (ANIs) and destination telephone numbers, which are used to generate local routing numbers (LRNs) for ported numbers, if applicable. ANIs and LRNs are evaluated over time to identify low quality and excess source and destination call attempts, which are throttled if outside of any number of predetermined network traffic quality of service parameters, limits, and ranges. To protect infrastructure, the system controls and throttles allocated bandwidth ranging between zero bandwidth and higher communications rates. The system throttles and optimizes traffic for durations ranging from short durations to days, and longer or permanently.

### TECHNOLOGICAL FIELD

The present disclosure relates generally to systems and methods for high-speed, high-volume telecommunication and network traffic routing, control, and management systems, including voice and data over internet protocol (VoIP) switches, such as class 4 hardware and software switches, which enables communication traffic between long distance carriers and competitive local exchange carriers (CLECs), private branch exchanges (PBXs), and similar class 5 internet protocol (IP) switches.

### BACKGROUND

Many challenges presently exist with current systems and methods available for allocating available telecommunications and network bandwidth to users attempting to initiate voice, data, and media connections between users and subscribers. Previously, dedicated and specialized local exchange carriers (LEC) “class 5” switches were geographically located near end users or subscribers having telephones and other devices that are connected to a public telephone switched network (PTSN). Because of limited bandwidth of legacy PTSN systems, such class 5 switches used an out of band signaling system 7 (SS7) to enable setup and tear down of calls. These systems formed part of the plain old telephone system (POTS). See, for example, en.wikipedia.org/wiki/Class-5_telephone_switch.

The telecommunications call traffic from such end-user subscribers was aggregated and communicated to geographically nearby “class 4” switches, which in turn further aggregated or trunked communications traffic. See, for example, en.wikipedia.org/wiki/Class-4_telephone_switch. The dedicated class 4 switches forwarding calls between other class 4 switches, and nearby class 5 switches, and to long distance class 3 (intermediate distance), 2 (longer distance), and 1 (backbone trunks, worldwide) carriers to enable termination or completion of calls between geographically remote end-user subscribers. Such class 1, 2, 3, 4, and 5 switches and related systems were vertically and horizontally integrated and owned by just a few large companies, which limited competition and innovation, and which led to break up of the companies and deregulation.

With the deregulation of the telecommunications industry and the concurrent advent and explosive growth of competition, the internet, and internet protocol (IP) in recent decades, many new technologies arose that enabled further competition and innovation. The vertical and horizontal ownership monopoly of long distance (class 1, 2, 3) and short-haul (class 4 and 5) carrier switches and systems was broken up into many different companies.

The new companies further increased competition as they divested inefficient aspects of their businesses, and endeavored to lower costs and improve efficiency to improve profitability in the new competitive environment. The long distance carriers saw the previous technical delineation between class 1, 2, and 3 carriers vanish as the technology that enabled long distance dedicated-voice telecommunications matured and merged to also enable long distance communications and IP network data and media communications traffic.

The new companies, then known as competitive LECs or CLECs, also further specialized into providing new capabilities in the class 5 and class 4 switch and systems technology areas. For example, class 5 providers developed new customer premises voice and data systems, which were compatible for use with internal customer IP and communications networks, which evolved from older wired private branch exchange systems (PBXs) into voice and data over IP of VoIP systems and VoIP PBXs, which could bypass legacy class 5, SS7 out-of-band wired switches, and use less expensive and more readily available IP internet connections to the outside world. The ubiquity of the internet has seen enhancements to legacy systems such as SS7, which has been upgraded in some places to use the internet, for example, SS7/IP switches.

Other parallel developments arose for local exchange class 4 switch providers who also moved away from dedicated and wired connections to legacy class 5 switches. Instead, by integrating compatibility with the communications and IP network, geographic proximity was no longer required so long as internet services were available between the target class 5 customer or subscriber, and class 4 provider or carrier. Additionally, competition continued to drive innovations as the technology that enabled class 4 and class 5 telecommunications switching overlapped with that for internet communications. Consequently, class 4 switching system providers or carrier were able to serve and connect customers or subscribers with carriers across any geographic distance.

As digital communications systems replaced older analog capabilities, the technical distinction between voice and other types of data matured into standards that decoupled the enabling hardware systems from the software technologies. More specifically, the enabling telecommunications hardware technologies evolved into standards and capabilities that were focused on communicating large volumes of high-speed telecommunications traffic without regard for the data content (voice, data, media) of the traffic.

Competitive business entities and research organizations developed an open system interconnection (OSI) seven layer model that describes the conceptual or logical architecture of the various elements of such communications systems. See, for example, http://en.wikipedia.org/wiki/OSI_model. Some technologists prefer a lower resolution model broadly describing such telecommunications systems as having four layers that include a physical and data link layer, a network and transport layer, and an application layer. Such various system models are compatible with one another, and are valuable tools for improving understanding and opportunities for interoperability. In any variation of the OSI model, there are two broad categories, a lower level physical, network, and data communications layers termed the “media layer” and a higher level communications layer containing the transport, session, presentation, and application layers termed the “host layer”.

With increased interoperability, compatibility, and unlimited access between CLECs, class 4 carriers, and long-distance carriers, many new challenges and problems have become apparent. For example, marketers, debt collectors, and similar business have sought to reach more targets using telecommunications and network infrastructure using auto dialing and automated contact management and voice messaging systems.

These systems often are configured with many types of multi-line systems that can auto-dial dozens, hundreds, and more destination telephone numbers rapidly and or simultaneously, which can inundate infrastructure with call routing requests. Often, such call routing requests also cannot be completed because the requests seek termination to destinations that are erroneous and have changed, do not exist, and which are out of service and or cannot otherwise be reached.

So while the telecommunications and network infrastructure attempts to accept such call routing requests, and to complete the call by attempting to reach such unreachable destinations, the infrastructure cannot be utilized by nominal traffic from routine callers to reachable destinations. This results in overwhelmed but underutilized infrastructure that is being inefficiently consumed by problematic traffic from subscribers and users that will never complete a call, and which will never be billed for infrastructure usage.

To compound the problem, such users that inject problematic traffic into the telecommunications systems, are not billed for incomplete calls even though the infrastructure is operating at capacity. This introduces seemingly insurmountable problems even for the highest-speed and highest-volume hardware and software class 4 switching systems. Further adding to this challenge, the quality of service for otherwise nominal users and customers can sometimes be drastically degraded during normal operation in that such nominal users and customers are confronted with service-unavailable and all-circuits-busy messages.

Despite the rapid advances in ever more powerful, high-speed and high-volume telecommunications and network infrastructure, such infrastructure for any particular class 4 tandem exchange or carrier, as well as for long distance class 1, 2, and 3 carriers, remains limited in bandwidth for the total number of calls per second (CPS) and concurrent sessions (CS) that can be accommodated and allocated, to enable call routing and forwarding for customers and subscribers. Typically, most such class 4 tandem exchange or carrier infrastructure can be and is configured to limit the CPS and CS for any particular subscriber or customer, which limits ensure the availability of bandwidth for the expected traffic of subscribers nominally making and completing calls, and according to the configured capacity of the infrastructure. Additionally, telecommunications technologists usually understand that the infrastructure required to enable providers and carriers to carry communications traffic is expensive to implement, and that it takes time to build out networks for the providers and carriers.

Consequently, the network communications marketplace is supply side limited, which forces providers and carriers to impose the CPS and CS limitations so that many demand side users, customers, and subscribers may utilize some bandwidth on the communications traffic networks. Unlike other commodities where supply can be increased through increased production, once installed and operational, the supply side communications networks cannot easily and rapidly increase bandwidth.

Therefore, the demand side customers and subscribers have struggled to find new ways to optimize utilization of the limited CPS and CS bandwidth so that only the most desired, highest quality traffic is switched or passed onto the limited bandwidth, supply-side carrier communications networks. In the past, some telecommunications providers and carriers have attempted to limit the available CPS and CS bandwidth by imposing a minimum cost and or profit limit to customer and subscriber traffic. However, such demand side cost controls have had limit beneficial effects.

Class 5 CLECs, class 4 tandem exchange and switch providers, and long-distance class 1, 2, and 3 carriers all seek to eliminate, control, throttle, and otherwise limit problematic traffic, and to allocate limited bandwidth resources to the traffic that is most likely to utilize and pay for the use of the infrastructure. At present, the most common methods employed by various systems impose the above-noted CPS and CS limits, which does not solve the need to identify and limit only problematic traffic, but which attempts to enable communication of desirable traffic.

Such problematic traffic can be difficult to limit when call routing requests are received from otherwise preferable LEC and CLEC subscribers and customers who may be forwarding the problematic autodialer traffic unintentionally. Additional challenges arise when such problematic traffic seeks to reach destination numbers that have been ported from their original exchanges to new exchanges, wherein the original numbering plan area (NPA) and local number prefix (NXX) are different for the new exchange.

Organizations in many countries, including the US FCC (fcc.gov) and US Number Portability Administration Center (napc.com), maintain, and have in-part delegated responsibility to maintain, current information about telephone numbers and telephone exchanges for all land-line and wireless users, which enables telecommunications providers to determine whether a land-line, wireless, or soft telephone user has changed telephone carriers and exchanges. These organizations support maintenance of number portability administration (NPA) databases that record the current exchange and telephone information for all end users, which enables users to change their service providers. The series of databases are known as the local number portability LNP databases for land-line users, and the full or wireless number portability FLNP, WLNP databases for wireless users.

These obstacles can be difficult to surmount when traffic volumes can exceed hundreds, thousands, or tens of thousands of call routing requests per second or more, which can require tens of thousands of call sessions or more, to enable termination or disposition of the requests.

What is needed is a new system and method for rapidly identifying and controlling, blocking, limiting, and throttling such problematic traffic or low quality traffic, and to ensure infrastructure resources and bandwidth are conserved and available to maintain service for high quality, preferred traffic. Also needed is a way to enable fast and efficient identification of specific call routing requests that enables limiting or blocking problematic traffic with a resolution to those specific, low quality call routing requests, while simultaneously enabling communication of higher quality traffic.

It is also needed to enable automated control of such specific, low quality traffic for a period of time so that such low quality traffic from identified sources does not consume infrastructure resources while such control persists. It is desirable to further enable such systems and methods to also rapidly identify problematic traffic from call routing requests that originate from specific sources and or that seek termination to unreachable destinations. Currently, no adequate solutions exist to also establish the capability to identify problematic or low quality traffic using any number of predetermined criteria, which can include one or a number of traffic characteristics.

An improved solution that enables these previously unavailable capabilities is described herein, which includes a telecommunication and network traffic control system and related methods that are configured to monitor, control, and throttle network traffic to limit and block problematic, unwanted, and harmful traffic. These new systems and methods are adapted to better optimize performance of and to protect telecommunications and network infrastructure from being consumed by such sub-optimal traffic.

### BRIEF SUMMARY

The systems and methods include new capabilities to enable telecommunication and network traffic control systems to optimize performance of and protect telecommunications and network infrastructure, including communications lines, trunks, switches, switch fabric, routers, gateways, controllers, border controllers, and related equipment and devices. The systems and methods enable greatly improved monitoring, control, and throttling of large volumes of high-speed network traffic to limit and block unwanted and harmful traffic, which enables infrastructure utilization for desirable, preferred, and intended network traffic. See, e.g., sipnavigator-com.

The new methods and systems include one or more processors, computers, virtual machines, and similar devices being configured with memory and storage and being coupled to a switch fabric in communication with an internet protocol (IP) network. Call routing requests are received by the one or more processors, which parse the routing requests to generate and communicate source automatic number identifications (ANIs) and destination telephone numbers (DNs or TNs).

The DNs are used to “dip” or make inquiries to routing databases, which enable generation of local routing numbers (LRNs) for DNs that may have been ported to a new exchange carrier from an original carrier. For DNs that have not been ported, the LRNs may be null, or may be identical or similar to the original DNs.

The systems and methods continuously accumulate, evaluate, and monitor the ANIs and LRNs over time periods, and identify possibly low quality call routing request attempts that have source ANIs and destination DNs exceeding a predetermined number of attempts. When such ANIs and LRNs are identified or detected, the systems and methods are configured to throttle, limit, and or block those call routing requests having ANIs and or LRNs that also have non-preferred characteristics.

Such non-preferred characteristics can include, for example, traffic quality of service parameters, limits, and ranges that do not meet or that are outside of predetermined settings and requirements, which settings and requirements determine efficient, optimized, preferred operations of the telecommunications and network infrastructure.

To protect the infrastructure, the systems and methods control, throttle, limit, and block the telecommunications and network traffic bandwidth that is allocated to call routing requests. The bandwidth allocations may range between zero bandwidth, for blocked call routing requests, or bandwidth established by preset or varying communications rates and volumes. The novel methods and systems may block, limit, throttle, and optimize such telecommunications and network traffic for durations ranging from short durations of seconds, minutes, and hours, to days, and longer, and may permanently effect such bandwidth controls.

In one exemplary configuration, the systems include a telephony network traffic throttle, having at least one processor that is coupled to a memory and a switch fabric. The throttle is configured to receive call routing requests via the switch fabric and to parse and communicate automatic number identifications (ANIs) from the routing requests. An ANI limiter is coupled to the at least one processor, and is configured to evaluate accumulated ANIs for a predetermined period of time and to identify those call routing requests, which have accumulated ANIs exceeding a call attempt limit during the predetermined period of time.

The ANI limiter is also configured to generate one or more ANI timed locks for the identified call routing requests, which have ANIs also meeting one or more predetermined ANI criteria. These one or more predetermined ANI criteria may include any number of communications traffic performance, quality, and cost parameters. For example, the ANI limiter can be configured to generate the one or more ANI timed locks for those ANIs having one or more of (a) an ANI short duration percentage (SDP) above an ANI SDP limit, (b) an ANI answer seizure ratio (ASR) below an ANI ASR limit, and (c) an ANI average call duration (ACD) below an ANI ACD limit, wherein criteria (a), (b), and (c) are some of the one or more predetermined ANI criteria.

The ANI limiter can also be configured to generate one or more of the ANI timed locks to have one or more ANIs and associated expiration times. Once generated, the at least one processor is further configured to communicate a service-unavailable reply to routing requests having unexpired ANI timed locks, and to forward routing requests having expired ANI timed locks or not having ANI timed locks.

In some configurations, the routing requests are and or may include session initiation protocol (SIP) requests, and the at least one processor is configured communicate a 503 service-unavailable SIP reply to such SIP requests that have unexpired ANI timed locks, and to forward SIP requests having expired or not having ANI timed locks.

Any of the preceding arrangements may also include at least one least cost router (LCR) in communication with a dynamic routing database, which is configured to receive the forwarded routing requests. Such forwarded routing requests also may each include a destination number. The at least one LCR router is configured to dip the dynamic routing database to generate a local routing number (LRN) associated with the destination number. One or more LCR logic mappers are coupled to the at least one LCR router, and are configured with a plurality of dynamically updated subscriber and carrier rate decks. The rate decks each have a plurality of rates for respective numbering plan areas/local number prefixes (NPAs NXXs).

The LCR logic mappers are configured to: (a) map a destination NPA NXX from the LRN, (b) scan the pluralities of rates for each of the subscriber and carrier rate decks of the plurality, using the mapped destination NPA NXX to identify available carriers, and (c) generate with the scan an LCR matrix for the destination NPA NXX including associated subscriber and carrier NPA NXX rates. The LCR router receives the LCR matrix and determines whether one or more acceptable carrier routes exist that enable forwarding of the routing request.

The one or more acceptable carrier routes may then be further filtered to include only those routes wherein the pluralities of rates in the LCR matrix generate greater than or equal to a minimum subscriber and or carrier gross profit amount per unit of time. In a variation, the one or more acceptable carrier routes are filtered, (a) by comparing in real-time with the routing requests the dynamically updated pluralities of subscriber and carrier NPA NXX rates, (b) to include only those routes wherein the pluralities of rates in the LCR matrix generate greater than or equal to a minimum subscriber and or carrier gross profit amount per unit of time.

In a different configuration, a telephony network traffic throttle includes at least one processor coupled to a memory and in communication with a routing database, which is configured to receive call routing requests and to parse and communicate destination numbers (DNs) from the routing requests. The at least one processor is also configured to use the DNs to dip the routing database to generate a local routing number (LRN) associated with each DN.

An LRN limiter is also coupled to the at least one processor, and is configured to evaluate accumulated LRNs for a predetermined period of time and to identify routing requests having accumulated LRNs that exceed a destination attempt limit during the predetermined period of time. The LRN limiter is also further configured to generate one or more LRN timed locks for the identified routing requests having LRNs that also meet one or more predetermined LRN criteria.

The LRN limiter is configured to generate the one or more LRN timed locks for those LRNs having one or more of (a) an LRN short duration percentage (SDP) above an LRN SDP limit, (b) an LRN answer seizure ratio (ASR) below an LRN ASR limit, and (c) an LRN average call duration (ACD) below an LRN ACD limit, wherein criteria (a), (b), and (c) are some of the one or more predetermined LRN criteria. The LRN limiter is also configured to generate one or more of the LRN timed locks to have one or more DNs, and associated LRNs and expiration times.

The at least one processor is also configured to communicate a service-unavailable reply to routing requests having unexpired LRN timed locks, and to forward routing requests having expired LRN timed locks or not having LRN timed locks. In some alternative arrangements, the routing requests are and or may include session initiation protocol (SIP) requests, and the at least one processor is configured communicate a 503 service-unavailable SIP reply to the SIP requests having unexpired LRN timed locks, and to forward SIP requests having expired or not having LRN timed locks.

In communication with one or more of the at least one processor is at least one least cost router (LCR router) coupled with a routing database, and configured to receive the forwarded routing requests and associated LRNs. The at least one LCR router is coupled to one or more LCR logic mappers, which are configured with a plurality of dynamically updated subscriber and carrier rate decks. The rate decks each having a plurality of rates for respective numbering plan areas/local number prefixes (NPAs NXXs).

The LCR logic mappers are configured to: (a) map a destination NPA NXX from the LRN, (b) scan the pluralities of rates for each of the subscriber and carrier dynamically updated rate decks of the plurality, using the mapped destination NPA NXX to identify available carriers, and (c) generate with the scan an LCR matrix for the destination NPA NXX including associated subscriber and carrier NPA NXX rates. The LCR router receives the LCR matrix and determines whether one or more acceptable carrier routes exist that enable forwarding of the routing request.

When desired, the acceptable carrier routes are filtered to include only those routes wherein the pluralities of rates in the LCR matrix generate greater than or equal to a minimum subscriber and or carrier gross profit amount per unit of time. The one or more acceptable carrier routes are filtered, (a) by comparing in real-time with the routing requests, the dynamically updated pluralities of subscriber and carrier NPA NXX rates, and (b) to include only those routes wherein the pluralities of rates in the LCR matrix generate greater than or equal to a minimum subscriber and or carrier gross profit amount per unit of time.

In additional arrangements, a method of throttling telephony network traffic includes providing at least one processor having a memory and in communication with an inbound switch fabric and an external network. The at least one processor is configured for parsing automatic number identifications (ANIs) from routing requests received from the external network, and for evaluating accumulated ANIs for a predetermined period of time.

The method of throttling telephony network traffic also includes identifying routing requests having accumulated ANIs that exceed a call attempt limit during the predetermined period of time. Next, generating for the identified routing requests is accomplished for one or more ANI timed locks for those ANIs that also meet one or more predetermined ANI criteria.

The generating step may also include generating the one or more ANI timed locks, to have one or more ANIs and associated expiration times, and for those ANIs having one or more of (a) an ANI short duration percentage (SDP) above an ANI SDP limit, (b) an ANI answer seizure ratio (ASR) below an ANI ASR limit, and (c) an ANI average call duration (ACD) below an ANI ACD limit, which are some of the one or more predetermined ANI criteria. Generating the one or more ANI timed locks to have one or more ANIs also may include generating associated expiration times.

The method of throttling telephony network traffic can be further configured for communicating a service-unavailable reply to routing requests having unexpired ANI timed locks, and for forwarding routing requests having expired or not having ANI timed locks. Further, the routing requests can be session initiation protocol (SIP) requests, wherein the communicating step includes communicating a 503 service-unavailable SIP reply to SIP requests having unexpired ANI timed locks, but forwarding SIP requests having expired or not having ANI timed locks.

The throttling method also includes receiving the forwarded routing requests that also each include a destination number, generating a local routing number (LRN) associated with the destination number by using the destination number to dip a routing database. Next, mapping a destination NPA NXX from the LRN is performed.

One or more LCR logic mappers is provided, which are configured with a plurality of dynamically updated subscriber and carrier rate decks each having a plurality of rates for respective numbering plan areas/local number prefixes (NPAs NXXs). The method is also adapted for scanning the pluralities of rates for each of the subscriber and carrier rate decks of the plurality using the mapped destination NPA NXX, and generating with the scanning an LCR matrix for the destination NPA NXX including carriers and associated NPA NXX rates. Then a step is executed of determining whether the LCR matrix includes one or more acceptable carrier routes exist that enable forwarding of the routing requests.

Filtering the acceptable carrier routes is accomplished to include only those routes wherein the pluralities of rates in the LCR matrix generate greater than or equal to a minimum subscriber and or carrier gross profit amount per unit time. Additionally, this step may be augmented for filtering the acceptable carrier routes (a) by comparing in real-time with the routing requests the dynamically updated pluralities of subscriber and carrier NPA NXX rates, (b) to include only those routes wherein the pluralities of rates in the LCR matrix generate greater than or equal to a minimum subscriber and or carrier gross profit amount per unit time.

In another configuration, a method of throttling telephony network traffic, includes providing at least one processor having a memory and in communication with an inbound switch fabric and an external network. The method is also adapted for parsing by the at least one processor, destination numbers (DNs) from routing requests received from the external network. The method is next configured for generating a local routing number (LRN) associated with each DN by dipping a routing database with the destination numbers.

The throttling method is then enabled for evaluating accumulated LRNs for a predetermined period of time, and for identifying routing requests having accumulated LRNs that exceed a destination attempt limit during the predetermined period of time, and for generating for the identified routing requests, one or more LRN timed locks having LRNs that also meet one or more predetermined LRN criteria.

The method for throttling telephony network traffic may also be configured for generating the one or more LRN timed locks, to have one or more DNs and associated LRNs and expiration times, and for those LRNs having one or more of: (a) an LRN short duration percentage (SDP) above an LRN SDP limit, (b) an LRN answer seizure ratio (ASR) below an LRN ASR limit, and (c) an LRN average call duration (ACD) below an LRN ACD limit, which are some of the one or more predetermined LRN criteria.

In other variations, the method is adapted for generating the one or more LRN timed locks to have one or more DNs, and associated LRNs and expiration times. If preferred, the method also is enabled for communicating a service-unavailable reply to routing requests having unexpired LRN timed locks, and for forwarding routing requests having expired or not having LRN timed locks.

In some configurations, the method receives routing requests that are session initiation protocol (SIP) requests, and is configured for communicating a 503 service-unavailable SIP reply to SIP requests having unexpired LRN timed locks, and then for forwarding SIP requests having expired or not having LRN timed locks. In any of the preceding method parts, the method of throttling telephony network traffic is adapted for receiving the forwarded routing requests and associated LRNs, and for providing one or more LCR logic mappers, which are configured as already described.

In other aspects of exemplary implementations of the telephony network traffic throttle and traffic throttling methods, the throttle and methods include a plurality of computer processors, transient memories and non-transient computer-readable storage media, network subsystems and interfaces, user interfaces and displays, switch fabric, and communications capabilities. These components and subsystems are or may be in part collocated, and are also configured in well-known geographically disparate, cloud-based arrangements that enable optimized and on-demand resource allocation, reliability, resilience, automated and near-instantaneous fail-over, and system-wide durability, using a variety of wide-available information technology architectures and implementations.

This summary of the implementations and configurations of the telephony network traffic throttle and traffic throttling methods is intended to introduce a selection of exemplary implementations, configurations, and arrangements, in a simplified and less technically detailed arrangement, and such are further described in more detail below in the detailed description. This summary is not intended to identify key features or essential features of the claimed technology, nor is it intended to be used as an aid in determining the scope of the claimed subject matter. The features, functions, capabilities, and advantages discussed here may be achieved independently in various example implementations or may be combined in yet other example implementations, as further described elsewhere herein, and which may also be better understood by those skilled and knowledgeable in the relevant fields of technology, with reference to the following description and drawings.

### BRIEF DESCRIPTION OF THE DRAWING(S)

A more complete understanding of example implementations of the present disclosure may be derived by referring to the detailed description and claims when considered with the following figures, wherein like reference numbers refer to similar elements throughout the figures. The figures and annotations thereon are provided to facilitate understanding of the disclosure without limiting the breadth, scope, scale, or applicability of the disclosure. The drawings are not necessarily made to scale, and include:

FIG. 1 is an illustration of a telephony network traffic throttle, systems, components, and methods;

FIG. 2 illustrates additional aspects of the system and methods of FIG. 1;

FIG. 3 depicts other aspects of the system and method of FIGS. 1 and 2 with various components and devices rearranged and or removed for illustration purposes;

FIG. 4 shows further capabilities and aspects of the system and method of the preceding figures, with certain capabilities depicted, and various components rearranged or removed for illustration purposes;

FIG. 5 illustrates an exemplary schematic of a hardware architecture of the system and methods of the preceding figures;

FIG. 6 depicts a method of throttling telephony network traffic with the system of FIGS. 1, 2, 3, 4, and 5;

FIG. 7 depicts additional aspects of the method of FIG. 6;

FIG. 8 describes another method of throttling telephony network traffic with the system of FIGS. 1, 2, 3, 4, and 5, and the methods of FIGS. 6 and 7; and

FIG. 9 illustrates additional aspects of the method of FIG. 8.

### DETAILED DESCRIPTION

The following detailed description is exemplary in nature and is not intended to limit the disclosure or the application and uses of the implementations, systems, components, and methods as set forth in the claims that follow. Descriptions of specific devices, techniques, methods, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding field, background, summary, or the following detailed description. The present disclosure should be accorded scope consistent with the claims, and not limited to the examples described and shown herein.

Example implementations of the present disclosure may be described herein in terms of schematic, functional, physical, and/or logical block components and various method and processing steps. It should be appreciated that such block components may be realized by any number of hardware, software, and/or firmware components customized and configured to perform the specified functions. For the sake of brevity, conventional techniques and components related to use during operations, and other functional aspects of the systems (and the individual operating components of the systems), may not be described in detail herein. In addition, those skilled in the art will appreciate that example implementations of the present disclosure may be practiced in conjunction with a variety of hardware, software, networked, internet-based, cloud-based configurations of the telephony network traffic throttle, systems, components, and traffic throttling methods, which may further incorporate various combinations of such implementations.

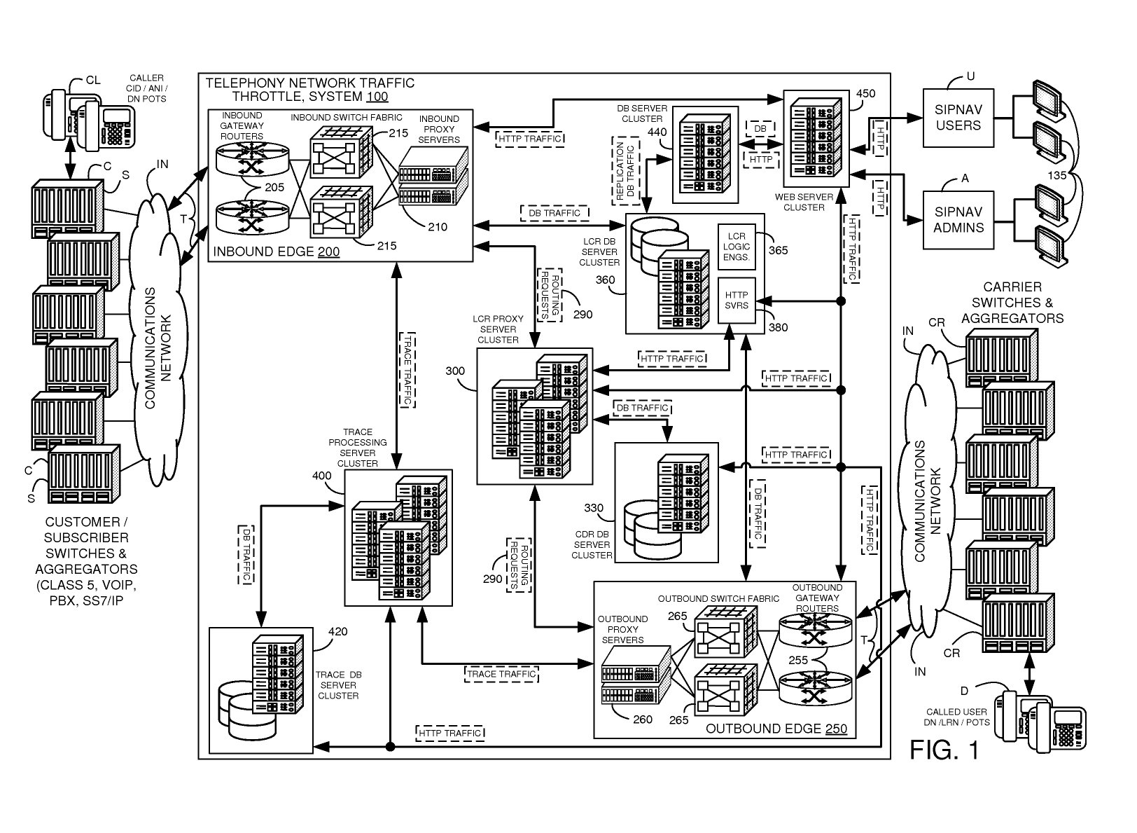

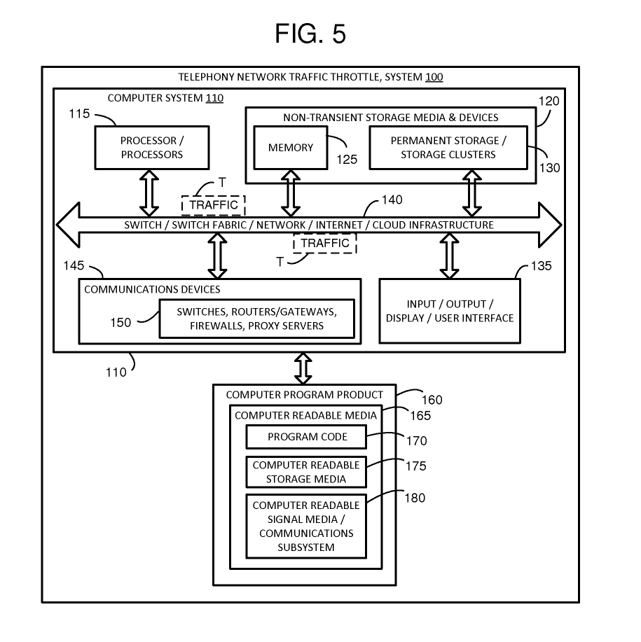

With reference now to the various figures and illustrations and specifically to FIGS. 1, 2, 3, 4, 5, 6, 7, 8, and 9, a telephony network traffic throttle and system 100 and methods 500, 600 for throttling network traffic T are described. With specific reference to FIG. 5, the throttle 100 and methods 500, 600 are implemented on at least one computer system 110 having at least one processor 115 in communication with one or more non-transient storage media 120 such as a memory 125 and a permanent storage and storage cluster(s) 130.

The computer system 110 and its components are coupled to input and output devices and a display that enable a user interface 135. The telephony network traffic throttle and system 100 is in communication with a network IN and switch fabric 140 via communications devices 145 that include switches, routers, firewalls, modems, and other similar network devices 150.

The telephony network traffic throttle and system 100 and related methods 500, 600 also contemplate being enabled and embodied in a computer program and computer program product 160, which includes computer readable media 165 on which is stored computer or program code 170 that can be further embedded on, stored on, and or retrievable from one or more computer readable storage media 175. Such code 170 enables the various components, configurations, and capabilities described elsewhere herein of the system 100 and methods 500, 600. A computer readable signal media and communications subsystem 180 is also shown that enables the system 100 and methods 500, 600 to operate on one or more of the actual and or virtual computer systems 110, which can operate in stand alone, combination, and clustered arrangements.

With these example architectural arrangements, various hardware and virtual hardware configurations can also be realized to enable the system 100 and methods 500, 600 to communicate and utilize such routers, networks, processors, servers, as well as server and storage clusters, which can include clustered, stand alone, virtual, and cloud computing hardware as a service (HaaS), platform as a service (PaaS), Internet as a service (IaaS), and among others, software and enterprise/environments as a service (SaaS, EaaS). These hardware and software infrastructure capabilities are available in-part from many vendors that include SipNav LLC (sipnavigator-com), Intel, Oracle, Hewlett-Packard, Cisco, Microsoft, VMWare, Amazon, and many others.

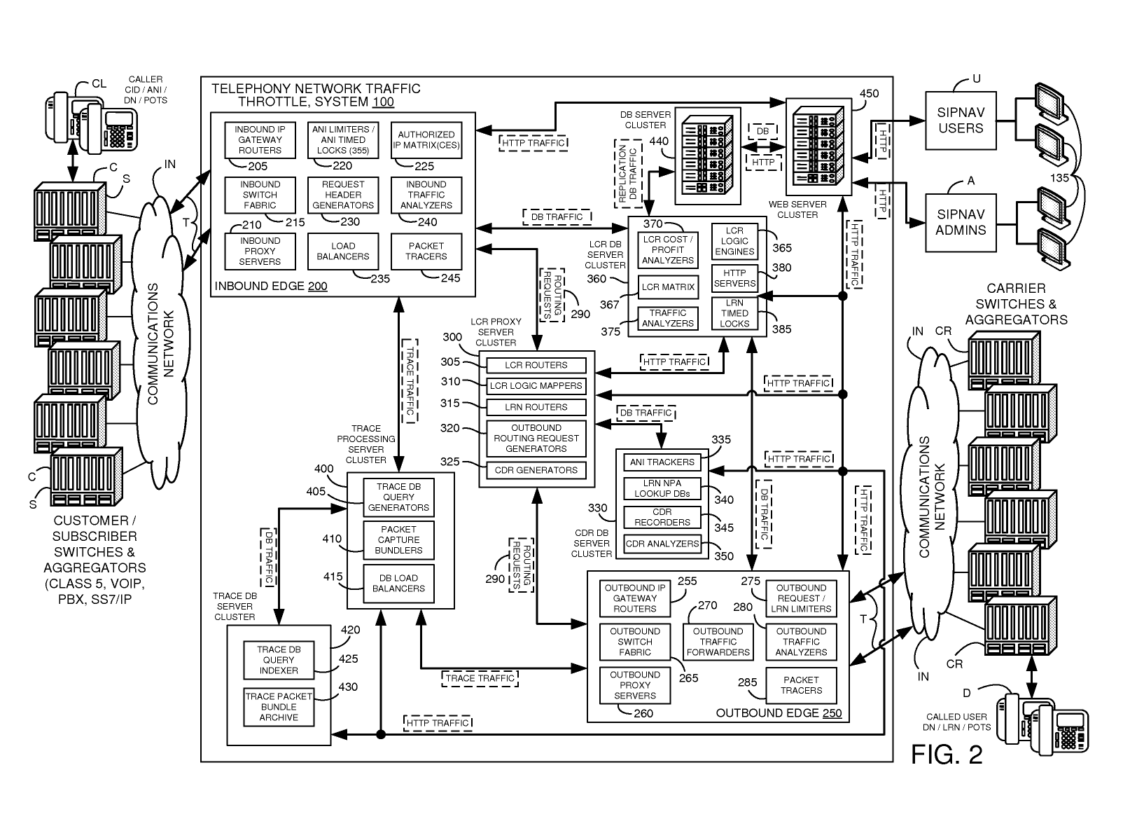

With reference now also to FIGS. 1 and 2, the telephony network traffic throttle and systems 100 are coupled to and in communication with external subscribers S, customers C, such as LECs and CLECs, and carriers CR via any number of various connections to Internet protocol (IP) and communications networks IN, often referred to in-part as the communications network, backbone network, carrier network, Internet and or as the public telephone switched network, (PTSN) among other common telecommunications references. The telephony network traffic throttle and systems 100 are configured to operate as a stand-alone system 100 operable with other systems to control traffic thereon, and can also be configured to be operable as part of and as an embedded element of such other systems. For example, the telephony network traffic throttle and systems 100 may be configured to enable new capabilities for existing and legacy switches and switching systems in a standalone arrangement, but to be operably connected to and embedded as an integral part of such switches and systems to enable new traffic control capabilities.

In an additional example, the telephony network traffic throttle and systems 100 may be embedded as part of telephony switches or switching systems. In either example, the telephony network traffic throttle and systems 100 will be in communication with an inbound edge 200 and an outbound edge 250 of such switches and systems. The inbound edge 200 will typically incorporate an inbound gateway router or routers 205 and inbound proxy server or servers or server clusters 210 coupled by an inbound switch fabric 215, which are configured to receive inbound traffic T from an external network such as the PTSN, communications and or telecommunications network, backbone, and internet network IN.

Although shown as separate devices for purposes of example, many telecommunications vendors and operators manufacture, configure, and enable stand alone systems that incorporate one or more or all of such devices into a single machine, which can be custom configured to enable one or more or all of the components and capabilities described in connection with the inbound edge 200.

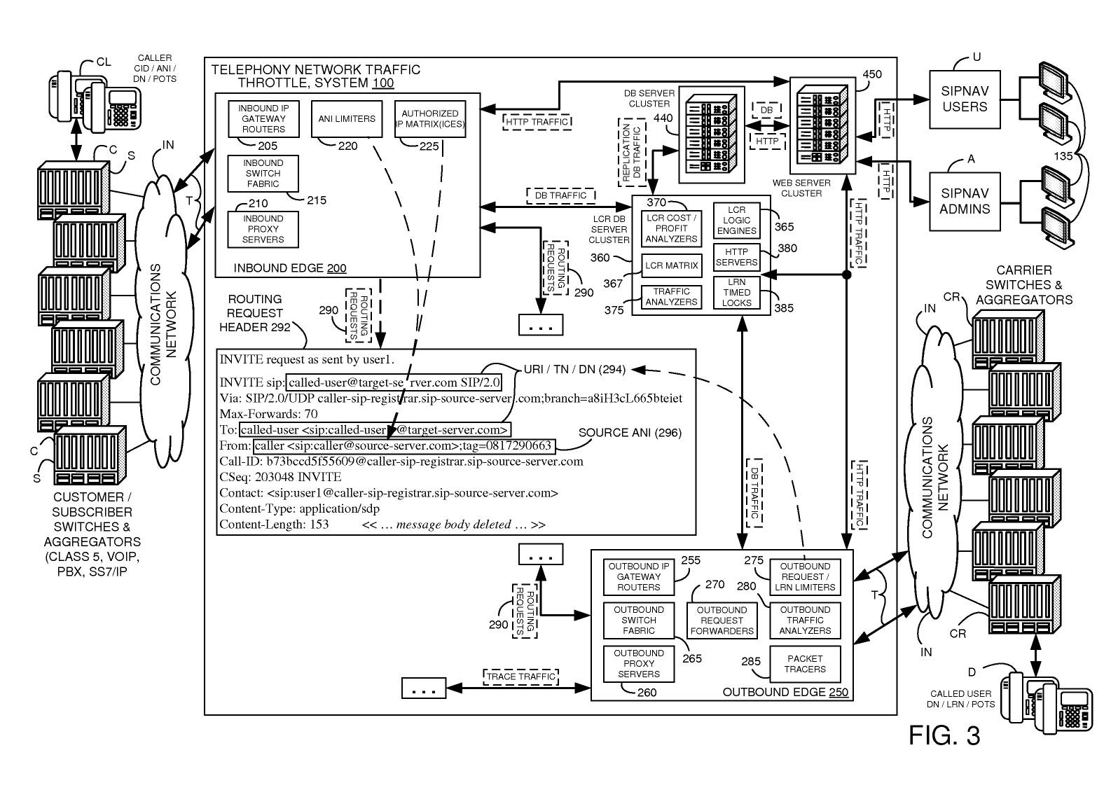

In some configurations, the inbound edge 200 is physically connected via the switch fabric 215 by the inbound gateway router or routers 205, which are configured with externally facing IP addresses and ports that enable the subscribers S and customers C to communicate with and utilize the systems 100. The routers 205 are also configured to enable inbound traffic T to be forwarded to other components of the systems 100, and may further be configured with various network security capabilities such as filters, firewalls, network address translation (NAT), and port forwarding elements. The inbound proxy servers 210 are configured for added security and resource load balancing capabilities, which enables inbound traffic T to be inspected for traffic routing requests 290 (FIG. 3), and routed to the appropriate other components of systems 100.

The telephony network traffic throttle 100 is also described in FIG. 2 as incorporating a number of additional components for purposes of illustration, and with the intent that such added components may be incorporated into the inbound edge 200 as well as other components of system 100. Those knowledgeable in the field of technology also should understand that such added components may also be incorporated across the other components of system 100 as well as across and as part of other systems coupled to, in communication with, operative with, and functioning cooperatively with the telephony network traffic throttle and systems 100. These added components of inbound edge 200, as well as the later described components, are depicted as being part of the inbound edge 200 only for purposes of describing one possible exemplary configuration, but not for purposes of limitation.

More specifically, in FIG. 2 the inbound edge is depicted to also incorporate at least one automatic number identification/identifier (ANI) limiter 220 in communication with the other components of the inbound edge 200 and system 100, and which can also be configured as a standalone component and also as an element of other components of systems 100. In such arrangements, the at least one ANI limiter 220 is configured to receive and evaluate network traffic T via the router or routers 205, inbound switch fabric 215 and inbound proxy server of servers 210, and to parse received routing requests 290 to identify source information, such as a source telephone number TN that may be in the form of an automatic number identification or identifier. These terms are in some applications and systems also referred to as source or caller identification CID, which is common with respect to plain old telephone systems POTS.

The ANI limiter is also configured to accumulate the inbound routing requests 290 for a predetermined period of time. The ANI limiter 220 is further configured to identify traffic T having routing requests 290 (FIGS. 1, 2, 3, 4) that are received from a caller or source CL that is generating a large number of routing requests 290 during the predetermined time period, which may exceed some predetermined ANI limit. The at least one ANI limiter 220 may be further configured to prevent forwarding of routing requests 290 that meet or do not meet additional criteria, and may be configured with additional capabilities and as described elsewhere herein.

At least one authorized IP matrix 225 is incorporated into the inbound edge 200, and can be included as a part of any other component in system 100 and or as a standalone device. The at least one authorized IP matrix 225 is configured to receive and store a plurality of matrices that include IP source addresses and related data, such as access credentials, security certificates, source proxy data, and other related data. The plurality of matrices identifies whether a caller or source CL is authorized to access the telephony network traffic throttle and systems 100, and can also include white list and black list data wherein white list data enables access to one or more components and capabilities of the systems 100, while blacklist data disables and prevents access to one or all components and capabilities of the systems 100.

The inbound edge 200 also incorporates for purposes of example, at least one routing request header generator 230, which can also be a part of other system components 100 among other variations. The routing request header generator 230 creates request headers that enable further routing of routing requests 290 through system 100 and to other external destinations. The generated request headers will typically include the IP addressing and authentication data needed to enable routing requests 290 to be received and decoded by external sources and destinations during operation of the systems 100.

In alternative variations of systems 100, at least one load balancer 235 is incorporated by the inbound edge 200 or another subsystem of component of systems 100, which is configured to balance the processor, storage, and switch fabric traffic internally and externally to and from the inbound edge 200 and other components of systems 100. In typical high-speed, high-volume traffic configurations, inbound traffic T and routing requests 290 may arise to tens of thousands or more routing requests or calls per second, and as many concurrently open sessions for each. Even with very large scale systems 100 having dozens or more processors 115 and virtual processors and related devices, any single processor 115 instance can be overloaded unless the load imposed by such traffic T and requests 290 is spread across all available resources. Accordingly, the at least one load balancer 235 enables optimized resource utilization of systems 100, and can also further be configured to enable fail over and cloud virtualization of various capabilities of systems 100 whereby additional hardware and software resources and instances are brought online during periods of component unavailability, failure, and or high utilization of the components of systems 100.

One or more traffic analyzers 240 are also depicted in FIG. 2 as being included in the inbound edge 200, but can also be incorporated into other parts of systems 100. The traffic analyzers 240 are configured to receive routing requests 290 and to parse various communications parameters therefrom. The analyzers 240 are also configured to enable characterization of the types and quality of the routing requests, and to accumulate various IP statistics for purposes of enabling forensic analyses. The accumulated IP statistics can also enable failure recovery, component error analyses and configuration optimization, and many other capabilities. Additionally included in inbound edge 200 or another component of systems 100 is one or more packet tracers 245, which are configured to parse specific IP addresses, tags, and port information from routing requests, and to generate and communicate trace route and ping and related analytical requests, which enables systems 100 to monitor for internal and external errors and traffic patterns.

In combination with the other devices of systems 100, the packet tracers 245 enable error detection, error correction, security enhancements, and troubleshooting capabilities. In turn, systems 100 utilize the inbound traffic analyzers 240 and tracers 245 to also detect and eliminate unauthorized traffic T that may attempt to access and utilize systems 100. Further, systems 100 can employ various configurations of the analyzers 240 and tracers 245 to cooperate with other components of systems 100, such as the trace server cluster 400, to substantially improve the quality of service provided to subscribers S, customers C, carriers CR, users U, and administrators A by detecting unoptimized or intermittently inoperable components, suboptimal load balancing, unauthorized uses, and suboptimal traffic patterns during operation of systems 100.

The outbound edge 250 incorporates outbound gateway routers 255 coupled by an outbound switch fabric 265 to outbound proxy servers 260. The routers 255, fabric 265, and proxy servers 260 are configured in similar ways to the comparable devices of the inbound edge 200, except that the outbound edge 250 devices 255, 260, and 265 receive the routing requests 290 and are optimized and configured for forwarding the requests 290 externally to carriers and aggregators CR and destinations D, to enable communication and eventual termination of the routing requests 290.

Outbound traffic forwarders 270 are incorporated with the outbound edge 250 (as depicted for an example in FIGS. 2, 3) and or any other components of outbound edge 250 and systems 100, and are configured to optimize, load balance, and if needed to encapsulate, error check, or wrap with a target or destination protocol the routing requests 290 before forwarding across the outbound proxy servers 260, and routers 255, to external carriers and aggregators CR and destinations or called users D.

The outbound edge 250 of FIGS. 2, 3 or another component or device of systems 100, further includes at least one outbound request limiter or local routing number (LRN) limiters 275. The LRN or outbound request limiters 275 may also be configured to operate in a standalone mode in communication with systems 100 and or is otherwise incorporated with the inbound edge 200 or any other component of systems 100. The LRN limiters 275 are configured to receive and evaluate network traffic T via the router or routers 205, inbound switch fabric 215 and inbound proxy server of servers 210, and to parse received routing requests 290 to identify a destination number DN or destination information, such as a source telephone number TN, which may be that same as the DN. Some communications protocols also refer to the TN or DN as a uniform resource identifier URI.

The LRN limiters 275 are further configured to “dip” or query an NPA database to determine if URI/DN has been ported. If it has not been ported, then the LRN limiters generate either a null local routing number LRN and or associates the LRN to be the same as the URI/DN. If the URI/DN has been ported to an exchange different from an original exchange that previously serviced the URI/DN, then the LRN limiters 275 generate an LRN for the new exchange, and associates it to the URI/DN. The LRN limiters 275 also accumulate the inbound routing requests 290 for a predetermined period of time.

The LRN limiter 275 is further configured to identify traffic T having routing requests 290 (FIGS. 1, 2, 3, 4) that are being routed to a destination a large number of times during the predetermined time period, which may exceed a predetermined LRN limit. The LRN limiters 275 may be further configured to prevent forwarding of routing requests 290 that meet or do not meet additional criteria, and may be configured with additional capabilities and as described elsewhere herein. For example, the predetermined LRN limit may be set to 100 attempts to reach the DN during a predetermined time period of 30 minutes, or any other desired limits or ranges.

When the predetermined LRN limit is exceeded, then the routing requests 290 are identified, and further evaluated. The at least one LRN limiter 275 may be further configured to prevent forwarding of routing requests 290 that meet or do not meet additional criteria, and may be configured with additional capabilities and as described elsewhere herein.

The outbound edge 250 of FIGS. 1, 2, 3, and 4, and or any other component of systems 100 also incorporates outbound traffic analyzers 280 and outbound packet tracers 285, which may be part of, standalone from, and or cooperatively configured to operate with the inbound traffic analyzers 240 and inbound packet tracers 245. The outbound traffic analyzers 280 and packet tracers 285 are configured to enable the same capabilities of their inbound counterparts, but with respect to the outbound traffic.

With continued reference to FIGS. 1 and 2, and further attention invited to FIG. 3, it can be understood that the various components of systems 100 are configured for receiving routing requests 290 in any number of presently and prospectively available communications protocols and formats. While the media layers of systems 100 are configured for communicating using ubiquitous internet physical, data, and network, and transport layer IP and ethernet protocols (See, e.g., above-described OSI 7 layer model), the systems 100 are also configured for use with a variety of host layer protocols (transport, session, application, and presentation) that can include, among many others now in use and prospectively available, including for purposes of example without limitation, session layer hypertext transfer protocols HTTP and session initiation protocols SIP. Although examples will now be described with respect to SIP protocols, this is for purposes of illustration but not limitation. SIP is used here since it offers a human readable format that makes for good demonstrative exemplars. There are many other present and prospective communications protocols that are compatible for use with the telephony network traffic throttle and systems 100.

A routing request header 292 is depicted in FIG. 3, which has been received with a routing request 290, and which is shown with a body of the routing request 290 removed for clarity in focusing on the content of the header 292. It should be known to those skilled in the field that the header 292, being formed as a SIP protocol “invite” request, includes among other data, a target destination number DN 294, which is also referred to as a called party telephone number TN, or a uniform resource identifier URI. In some instances, the SIP request 290 and header 292 may also include an LRN.

However, even if an LRN is included, the DN is dipped in an NPA database to confirm it is accurate. As a billing fraud prevention and error checking capability, LRNs are typically generated by the systems 100 to ensure accurate resource utilization and billing. If the received LRN is different than the LRN generated from the dip or query to an NPA database, then additional criteria may include an error flag that can be used to limit or block calls from the associated ANI and or to the associated DN.

The telephony network traffic throttle and systems 100 also incorporate a least cost router LCR proxy server cluster 300, which is configured to intermediate communications of routing requests 290 and related data between the inbound edge 200 and the outbound edge 250, among many other capabilities. As routing requests 290 are received and forwarded between the edges 200, 250, the other needed resources of systems 100 are drawn upon by the LCR proxy server cluster 300 to enable operation of the systems 100. The LCR proxy server cluster 300 includes one or more LCR routers 305, LCR logic mappers 310, LRN routers 315, outbound routing request generators 320, and call detail record CDR generators 325.

A CDR database DB server cluster 330 is in communication with the LCR proxy server cluster 300 and is configured to receive and store generated CDRs for system performance tracking, record keeping, and billing. The CDR DB further includes ANI trackers 335, LRN NPA lookup dynamic routing DBs 340, CDR recorders 345, and CDR analyzers 350. The ANI trackers 335 are configured to receive and accumulate ANIs 296 cooperatively with and or on behalf of the ANI limiters 220 and to identify ANIs 296 that accumulate in excess of a predetermined limit during a predetermined period of time. For example, if a specific source ANI 296 is accumulated over 100 times during a 30 minute period, or any other preferred limit or range, then that ANI 296 would be identified, and further analyzed against other additional, predetermined criteria.

The ANI limiters 220, ANI trackers 335, and or the CDR analyzers 350 in another arrangement are configured, either alone, separately, as a single combined device, and or in cooperation with each other, to generate an ANI timed lock 355 (FIG. 2) and communicate it to the ANI limiters 220 at the inbound edge 200. The timed lock 355 is configured to include a time duration, such as 24 hours, associated with the identified ANI that meets one or more of the additional criteria. The time duration may be shorter or longer, and may be designated in units of second, minutes, hours, days, and other units.

The ANI limiters 220 are also configured to generate the one or more ANI timed locks 355 for the identified call routing requests 290, which have ANIs 296 that also meeting one or more predetermined, additional ANI criteria. For example, the ANI limiters 220 can be configured to generate the one or more ANI timed locks 355 for those ANIs having one or more of additional, predetermined criteria that include, for illustration purposes but not limitation, (a) an ANI short duration percentage (SDP) above an ANI SDP limit, (b) an ANI answer seizure ratio (ASR) below an ANI ASR limit, and (c) an ANI average call duration (ACD) below an ANI ACD limit, wherein criteria (a), (b), and (c) are some of the one or more additional, predetermined ANI criteria. Those knowledgeable in the technology should understand that many other criteria are also known and available for use to enable additional capabilities to the ANI limiters 220.

As a further example, identified ANIs 296 may be evaluated by the ANI trackers 335, the ANI limiters 220, and or the CDR analyzers 350, against an additional, predetermined criteria, for illustration purposes but not for limitation, to determine if they are associated with routing requests 290 that have an average call duration (ACD) below a certain ANI ACD limit, such as below 6 seconds. They may be evaluated to discern if they have a short duration percentage (SDP) above an ANI SDP limit, such as 35%. The ANIs 296 may be analyzed to determine if the ANI has an answer seizure ratio (ASR) below an ANI ASR limit, such as below about 15%. Any other preferred limits and ranges for these criteria and others are also compatible for use as described.

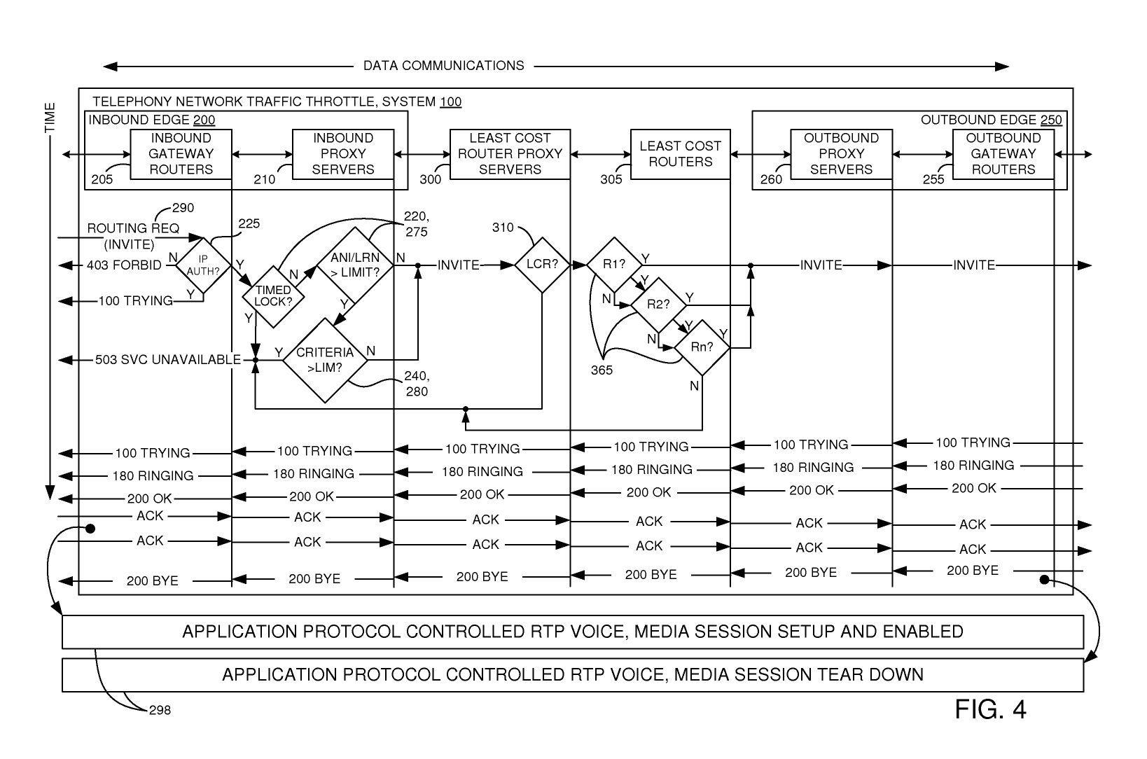

During the unexpired time of the ANI timed lock 355, prospective routing requests 290 having the identified ANIs 296 are detected by the ANI limiters at the inbound edge 200, and are not forwarded. The unforwarded routing requests 290 may or may not be sent a reply, and if a reply is communicated, then it can indicate that the request is refused. In the example of a SIP formed routing request 290, a reply such as “403 forbidden” and or “503 service unavailable,” or any other appropriate message may be sent. See, for example, FIG. 4. Additionally, in alternative arrangements, the ANI timed lock 355 may be utilized by other components and devices of systems 100 to forward a limited amount of routing requests 290 to thereby throttle the bandwidth available to forward routing requests 290 having unexpired ANI time locks 355. The bandwidth may be throttled or constrained to amounts between zero, that is no forwarding, and higher data communication rates as may be desired.

The LRN NPA lookup dynamic routing DBs 340 are configured with internally maintained, frequently updated and or real-time, dynamically updated NPA LNP, FLNP, WLNP databases, which include the exchange local routing numbers LRNs for all TNs, DNs, and URIs. The dynamically and or real-time updated DBs 340 ensure that accurate, as up-to-date as possible LRNs are continuously available as DNs are ported between exchanges.

The CDR recorders 345 are configured to record each call detail record (CDR) generated by the CDR generators 325 and to communicate the recorded CDRs to the trace DB server cluster 420. In addition to the previously described configurations, the CDR analyzers 350 are also configured to generate performance and statistical analyses of systems 100, as needed by users U and administrators A for troubleshooting errors, billing, and forensic evaluations and analyses needed to optimize and maintain the systems 100.

For routing requests 290 that do not have ANIs 296 that exceed the ANI limits, the routing requests 290 are forwarded as described elsewhere herein, to enable establishment and eventual tear-down of voice, media sessions 298. An example of the timing and data communications exchanged between systems 100 and external carriers and aggregators during voice, media session set-up, establishment, and tear-down are illustrated in FIG. 4.

The LCR routers 305 are configured to receive the DNs parsed from the routing request, and to poll the LRN routers 315, which are configured to dip the DNs against the LRN NPA lookup dynamic routing DB s 340, to thereby determine if the DNs have been ported, and if so, to generate the destination LRN. With the destination LRN or confirmation of a non-ported DN, the LCR routers 305 are further configured to poll the LCR logic mappers 310 and scan the dynamic routing DBs 340 for one or more acceptable routes to the DN or LRN of the routing request 290.

Acceptability of routes is determined by any number of supply side carrier availability, performance, and cost/rate parameters, which can include for illustration purposes but not limitation, supply side (a) availability of circuits of the carrier CR, (b) availability of carrier CR bandwidth as a function of CPS and CS limits, (c) availability of any route to the destination NPA NXX of the carrier CR, (d) availability of authorization of the subscriber S and or customer C to utilize an otherwise available carrier CR, carrier CR quality of service parameters, characteristics, and statistics, and (e) carrier route rates that meet demand side subscriber S and customer C cost limits and requirements. The LCR logic mappers 310 then generate from the scan an LCR matrix 367 of possible routes, wherein the LCR matrix 367 identifies carriers CR that service the route, and respective rates from current, dynamically updated rate decks defining the costs for each such route.

The LCR logic mappers 310 communicate with the LCR DB server cluster 360, and its LCR logic engines and LCR cost/profit analyzers 370, to further filter the one or more acceptable routes in the scan generated LCR matrix 367 to the DN or LRN, filtered by predetermined cost and or profit limits. The cost or profit limits ensure that routes are selected in the generated LCR matrix 367 that meet a minimum cost and or profit limit, which is predetermined and set by the customers C and or subscribers S via the users U or administrators A. The LCR logic mappers 310 may also communicate with any of the other components and devices of systems 100 to filter the acceptable routes according to other preferred carrier CR availability and performance parameters such as those noted above.

While rate cost per unit time for a particular route is useful to ensure minimized costs, it is more optimal to compare the subscriber S and customer C rates to the carrier rates per unit time, to ascertain whether a route is available that meets or exceeds a predetermined profit. Even more preferably, the routes in the LCR matrix 367 are further filtered to identify acceptable routes that meet or exceed a profit of a predetermined amount per unit time, which amount is defined to be one or more of a minimum percentage profit per unit time, a minimum profit amount per unit time, and or a minimum cumulative profit amount for an estimate call duration, and or combinations thereof.

Most preferably, the LCR matrix 367 is further filtered to include only those routes that meet or exceed one or more of a gross profit limit for a subscriber and or a carrier route minimum gross profit. The gross profit is computed to be the difference between one or more of the (a) carrier rate cost for a specific route and the rate charged for forwarding the routing request 290 to the specific route, and (b) the difference between the carrier rate cost for a specific route and the subscriber rate that is charged for forwarding the routing request 290 to the specific route. The minimum gross profit limits can be predetermined and set as noted above for either the subscriber and or the carrier, and combinations thereof.

The capability to select predetermined gross profit limits and or similar cost and profit limits for the demand side customer C and subscriber S has in some circumstances enabled limited optimization and somewhat better utilization of telecommunications infrastructure such as systems 100. However, the capability to select predetermined gross profit limits and related cost and profit limits for the limited bandwidth, CPS and CS limited, supply side carriers CR has demonstrated extraordinary and previously unseen benefits during operation of the telephone network traffic control throttle and systems 100. More specifically, this new capability to select predetermined gross profit and related limits for each carrier route in all carrier rate decks has enabled greatly improved utilization of the limited supply side bandwidth of the carriers CR by only the highest quality traffic T.

The increase in profitability has led to unexpected results in that both carriers CR and customers C and subscribers S are better equipped to reinvest in infrastructure improvements to further increase capacity and capability of telecommunications infrastructure. These improvements have, in turn, led to higher quality of service for customers C and subscribers S because telecommunications infrastructure of supply side carriers CR is more readily available for use when needed, since it is not overwhelmed or consumed with passing lower quality communications traffic.

The supply side CPS-CS-limited bandwidth of carriers CR can now more readily be made available for high quality communications traffic, instead of otherwise being consumed with lower quality traffic that may never complete a call and pay for infrastructure utilization, Additionally, configuring and using the LCR logic mappers 310 and LCR matrices 367 to enable forwarding of only the highest quality routing requests 290 to only those LCR matrix 367 filtered carrier routes, the CPS-CS-limited supply side bandwidth of the available telecommunications infrastructure is protected from inefficient, suboptimal utilization. In other words, forwarding of routing requests 290 can now be controlled by throttling and or blocking routing requests 290 having undesirable or low quality ANIs, LRNs, or cost profiles.

With the filtered route LCR matrices establishing availability of optimal and acceptable carrier routes that meet the various criteria, the outbound routing requests generators 325 are configured to wrap the inbound routing requests 290 with additional forward routing header data that is similar to the routing request headers 292, which enables systems 100 to further forward the routing requests 290 to the outbound traffic forwarders 270 of the outbound edge 250, and externally. Concurrently, the CDR generators 325 are configured to generate call detail records (CDRs) that record the instance of the forwarded routing requests 290, and to monitor termination setup, establishment, and eventual tear-down of the established voice, media sessions 298 (FIG. 4). The CDR generators 325 are also configured to communicate the in-process and completed CDRs to the CDR recorders 345 and the trace DB server cluster 420.

An LCR DB server cluster 360 is coupled to and communicates with the LCR proxy server cluster 300 and includes LCR logic engines 365, LCR cost/profit analyzers 370, traffic analyzers 375, and HTTP servers 380. The LCR logic engines 365 include one or more or a plurality of dynamically updated rate decks for each carrier CR that is enabled to receive forwarded traffic from systems 100. Here, dynamically updated refers to accurately and dynamically updated and continuously maintained rate decks that ensure the most up-to-date and authorized rates are available for use by the systems 100. Each such rate deck includes rates of cost per unit time, such as seconds, decimal minutes, etc., for calls placed to each NPA/NXX destination area and exchange serviced by the carrier CR. The LCR logic engines 365 also include one or more rate decks for each NPA/NXX destination as set by each subscriber S and or customer C that are enabled to utilize the resources of the telephony network traffic throttle and systems 100.

The LCR cost/profit analyzers 370 are configured to calculate the costs of a using a carrier route for a specific DN routed to the NPA/NXX, and to further calculate the profit for a customer C or subscriber S using the carrier route, using in both cases the rate decks applicable to the carrier route. The traffic analyzers 375 are configured to generate cost, profit, and related statistics for each completed routing request 290 using the data generated by the LCR logic engines 365 and the LCR cost/profit analyzers 370, and to store the data for each completed routing request 290 to the DB server cluster 440. The HTTP servers 380 are configured, among other capabilities, to receive and communicate the rate decks between the LCR logic engines 365 and the customers C, subscribers S, users U, and administrators A for maintenance, updates, and other systems requirements. Many additional capabilities and requirements may be understood by those skilled in the field with reference to an exemplary implementation available at sipnavigator-com.

In an additional arrangement, the systems 100 also further incorporate a trace processing server cluster 400, which is in communication with the other components of systems 100. The trace processing server cluster 400 is configured to receive and capture all communications trace traffic for the routing requests 290 being received and forwarded by the systems 100. The communications trace traffic may include for purposes of example but not limitation, TCP/IP communications details that include source, destination, intermediate hops, timing, and related traffic performance data. In another example, the trace traffic that is recorded may include SIP trace information that includes source, destination, intermediate hops, and related performance and timing data. The trace processing server cluster 400 also includes trace DB query generators 405, packet capture bundlers 410, and DB load balancers 415.

The trace DB query generators 405 are configured to cooperate with other components of systems 100 such as the analyzers and tracers 240, 245, 280, 285 to create, communicate, and capture responses to trace route, nslookup, dig, whois, ping, and other network forensic and diagnostic queries and requests, which enable monitoring, optimization, error correction, and re-routing of telephony network traffic within and external to the telephony network traffic throttle and systems 100. The packet capture bundlers 410 are configured to cooperate with the generators 405 and also to monitor and continuously collect, bundle into discrete archives that span a limited number of packets and or a limited time period, all network communications traffic including the HTTP, DB, trace, and other internal traffic of systems 100, as well as the external traffic passing through the systems 100.

By continuously capturing and bundling all such traffic, the systems 100 enable detailed and comprehensive forensic analyses of all past and real-time, present communications, so that errors and issues can be examined and corrected quickly, without the time consuming and unreliable need to reconstruct what may have happened previously. In the past, when errors and issues arose during operation, administrators A and users U were required to attempt to guess at and re-create the past conditions that may have resulted in such errors and issues. This often is impossible in view of the many continuously changing variables of systems 100 during operation. But now, with all historical details of communications traffic being available, the capability to detect, evaluate, and then correct such issues and errors is possible, without the need to attempt to recreate what may have happened.

A trace DB server cluster 420 is also in communication with the trace processing server cluster 400, and the other components of systems 100. A trace DB query indexer 425 and a trace packet bundle archive 430 are incorporated with the trace DB server cluster 420, and communicates DB traffic with the trace proxy server cluster 400. The DB query indexer 425 receives and indexes for autonomous and continuous operation, and or rapid retrieval, the queries generated by the trace DB query generators 405. The trace packet bundle archive 430 stores the generated bundles from the packet capture bundlers 410.

The trace DB server cluster also communicates data via HTTP traffic with the CDR DB server cluster to capture network trace data from recorded CDRs and trace data from other components of the systems 100. For example, network trace data can also include data generated by the CDR analyzers 350, inbound and outbound traffic analyzers 240, 280 and by the inbound and outbound packet tracers 245, 285.

Another configuration of the telephony network traffic throttle and systems 100 includes a replication DB server cluster 440 in communication with the other devices of the systems 100, and configured to replicate the other systems 100 databases using any one of many possible high-speed, real-time database replication traffic and protocols. For example, database durability and real-time replication can be optimized using snap-shotting or semi-persistent data replication and storage techniques, which can employ data sharding and other optimization and replication best practices, which can replicate operational system data without consuming resources of the operational systems 100.

Many such data and database replications systems are available, and can include for example without limitation, real-time Redis or similarly capable NoSQL database implementations. Such databases can be configured for high-speed, real-time operation in a virtual machine (VM) clustered configuration wherein the random access memory RAM of the VMs can be clustered to enable Redis databases to be continuously rebalanced in both RAM resident and disk stored variations. In the example of a Redis implementation, many auto balancing options are possible to enable various system performance requirements, which can be optimized and controlled by the load balancers 235, 415 of the systems 100.

This capability enables persistent, continuous, real-time data replication to ensure fail-safe and fail-over data persistence and protection during operation of the systems 100. Coupled to and in communication with the systems 100 is an included web server cluster 450, which is configured to also communicate with users U and administrators A of the systems 100 and its components, and to detect input and generate and communicate output via HTTP traffic channels to one or more input, output, display, and user interface devices 135. The web server cluster 450 is configured to monitor, generate, and communicate various systems 100 operational and control parameters and data via internal presentation, application, and session layer HTTP traffic.

The many components and devices of the systems 100 have been described as distinctly separate, specifically configured components and devices, configured and incorporated into one or more clusters or subsystems of systems 100. However, it is intended that these components and devices in different arrangements of systems 100 are also to be configured to be included in other such clusters and subsystems. Further, it should be apparent to those skilled in the relevant fields of technology, that the devices and components are also susceptible to being configured as combined, multifunctional devices and components wherein one such reconfigured arrangement is configured as two or more of the earlier described devices and components.

For example without limitation, in certain variations of the systems 100, it is desirable to combine or embed the LCR routers 305, the LCR logic mappers 310, and the LCR logic engines 365 as one multifunctional LCR device embedded on one or more of the LCR proxy server cluster(s) 300, the LCR DB server cluster(s) 360, and or another subsystem, and or across multiple other subsystems of the systems 100. A similar alternate configuration is also appropriate for other of the described components and devices of the systems 100.

Similarly, while the telephony network traffic throttle and systems 100 are illustrated to include various proxy servers and server clusters 210, 260, 300, 330, 360, 400, 420, 440, 450, it should be understood that one or more such servers and clusters may be configured as additionally independent servers and clusters, and also as combined servers and clusters using one or more of the contemplated computer systems 110, and related processors 115 and cooperative components and devices. As used here, the term clusters means one or more and or at least one computer systems 110. More specifically, we describe a server or computer cluster to include one or more of loosely or tightly connected or coupled computers in communication with each other, which operate together so that for some configurations, the clustered computers 110 and or processors 115 operate as a single system.

In all configurations, the servers and clusters of systems 100 are arranged to work together as a single system, which enables high-speed, high-volume, high availability of the constituent components and devices of systems 100. When a permanent or intermittent error or failure occurs on one processor 115 or computer system 110 in the servers and server clusters, the capabilities of the server and cluster devices and components are instantly reallocated and the workload is redistributed to another of the computer systems 110 and processors 115 in the servers and clusters.

In another arrangement of the systems 100, and with continued reference to FIGS. 1, 2, 3, 4, and 5, during operation call routing requests 290 are received by the one or more processors 115, which may be incorporated in one or more of the devices of the inbound edge 200 and the LCR proxy server cluster 300. The one or more processors 115 parse the routing requests 290 and generate and communicate source ANIs 296 and destination telephone numbers (DNs, TNs) 294. The ANIs 296 and DNs 294 are received by one or more of the LCR proxy and LCR DB server clusters 300, 360, which “dip” or make inquiries with the DNs to the LRN NPA lookup or dynamic routing databases 340. One or more of the CDR DB, LCR proxy, and or PCR DB server clusters 330, 300, 360 generate local routing numbers (LRNs) for DNs 294, which may have been ported to a new exchange carrier CR from an original carrier CR. For DNs 294 that have not been ported, the LRNs may be null, or may be identical or similar to the original DNs 294.

In another exemplary adaptation, the systems 100 include a telephony network traffic throttle 100, which has at least one processor 115 that is coupled to a memory 125 and a switch fabric 215. The throttle 100 is configured to receive call routing requests 290 via the switch fabric 215 and to parse and communicate automatic number identifications (ANIs) 296 from the routing requests 290. An ANI limiter 220 is coupled to the at least one processor 115, and is configured to evaluate accumulated ANIs 296 for a predetermined period of time and to identify those call routing requests 290, which have accumulated ANIs 296 exceeding a call attempt limit during the predetermined period of time.

The ANI limiter 220 is also configured to generate one or more ANI timed locks 355 for the identified call routing requests 290, which have ANIs 296 that also meet one or more additional, predetermined ANI criteria. For example, the ANI limiter 220 is configured to generate the one or more ANI timed locks 355 for those ANIs 296 having one or more of (a) an ANI short duration percentage (SDP) above an ANI SDP limit, (b) an ANI answer seizure ratio (ASR) below an ANI ASR limit, and (c) an ANI average call duration (ACD) below an ANI ACD limit, wherein criteria (a), (b), and (c) are some of the one or more additional, predetermined ANI criteria.

The ANI limiter 220 is also configured to generate one or more of the ANI timed locks 355 to have one or more ANIs 296 and associated expiration times. Once the one or more timed locks 355 are generated, the at least one processor 115 is further configured to communicate a service-unavailable reply to routing requests 290 having unexpired ANI timed locks 355, and to forward routing requests 290 having expired ANI timed locks 355 or not having ANI timed locks.

In alternative configurations for a specific host layer protocol, the routing requests 290 are and or may include session initiation protocol (SIP) requests 290. In this variation, the at least one processor 115 is configured communicate a 503 service-unavailable SIP reply to such SIP requests 290 that have unexpired ANI timed locks 355, and to forward SIP requests 290 having expired or not having ANI timed locks 355.

The preceding arrangements of systems 100 also may include at least one least cost router (LCR router) 305 in communication with a dynamic routing database 340, which is configured to receive the forwarded routing requests 290. As with preceding variations, the at least one LCR router 305 dips the dynamic routing database 340 and generates generate an LRN associated with the destination number. One or more LCR logic mappers 310 are coupled to the at least one LCR router 305, and include a plurality of dynamically updated subscriber and carrier rate decks. The dynamically updated rate decks each have a plurality of rates for respective numbering plan areas/local number prefixes (NPAs NXXs).

The LCR logic mappers 310 are configured to: (a) map a destination NPA NXX from the generated LRN, (b) scan the pluralities of rates for each of the subscriber and carrier rate decks of the plurality, using the mapped destination NPA NXX to identify available carriers, and (c) generate with the scan an LCR matrix 367 for the destination NPA NXX including associated subscriber and carrier NPA NXX rates. The LCR router receives the LCR matrix 367 and determines whether one or more acceptable carrier routes exist that enable forwarding of the routing request 290.

The one or more acceptable carrier routes are further filtered to include only those routes that are acceptable for forwarding the routing requests 290, wherein the pluralities of rates in the LCR matrix 367 generate greater than or equal to a minimum limit subscriber and or a minimum limit carrier gross profit per unit of time.

In a variation, the one or more acceptable carrier routes that are acceptable for forwarding the routing requests 290 are filtered, (a) by comparing in real-time with the routing requests 290 the dynamically updated pluralities of subscriber and carrier NPA NXX rates, and (b) to include only those routes wherein the pluralities of rates in the LCR matrix 367 generate greater than or equal to a minimum limits of subscriber and or carrier gross profit amount per unit of time, if used to forward the routing requests 290. As previously described, the LCR logic mapper 310 filtering to include only the acceptable carrier routes, protects the supply side CPS-CS-bandwidth-limited, available routes of the carriers CR so that such limited bandwidth is optimized for utilization by the most preferred routing requests 290 and traffic T, instead of otherwise being inefficiently overwhelmed by lower quality traffic T.

In a different configuration, a telephony network traffic throttle and systems 100 include at least one processor 115 that is coupled to a memory 125, which are in communication with a routing database 340. The at least one processor 115 is configured to receive call routing requests 290, and to parse and communicate DNs 294 from the routing requests 290, which are formed as part of a routing request header 292. The at least one processor 115 is also configured to use the DNs 294 to dip the routing database 340 to generate an LRN associated with each DN 294.

An LRN limiter 275 is also coupled and or in communication with to the at least one processor 115, and is configured to evaluate accumulated LRNs for a predetermined period of time. The processor 115 also identifies routing requests 290 having accumulated LRNs exceeding a destination attempt limit during the predetermined period of time. The LRN limiter is also further configured to generate one or more LRN timed locks 385 for the identified routing requests having LRNs that also meet one or more predetermined, additional LRN criteria.

The LRN limiter 275 is configured to generate the one or more LRN timed locks 385 for those LRNs having one or more predetermined, additional criteria of, for purposes of example without limitation, (a) an LRN short duration percentage (SDP) above an LRN SDP limit, (b) an LRN answer seizure ratio (ASR) below an LRN ASR limit, and (c) an LRN average call duration (ACD) below an LRN ACD limit, wherein criteria (a), (b), and (c) are some of the one or more predetermined LRN criteria. The LRN limiter 275 is also configured to generate one or more of the LRN timed locks 385 to have one or more DNs 294, and associated LRNs and expiration times.

As a further example, identified LRNs and DNs 294 may be evaluated by the LRN limiters 275, and or the CDR analyzers 350, against an additional, predetermined criteria, for purposes of example without limitation, to determine if they are associated with routing requests 290 that have an average call duration (ACD) below a certain LRN ACD limit, such as below 6 seconds or more or less. The LRNs/DNs 294 may also be analyzed to ascertain if they have a short duration percentage (SDP) above an LRN SDP limit, such as 35%. The LRNs may be analyzed to determine if the LRN has an answer seizure ratio (ASR) below an LRN ASR limit, such as below about 15%. The LRN and ANI limits described here and previously may be independent, and or dependent upon one another, and combinations thereof, and may be selected to have other limits and ranges beyond the examples described here.

The at least one processor 115 is also configured to communicate a service-unavailable reply to routing requests 290 having unexpired LRN timed locks 385, and to forward routing requests having expired LRN timed locks 385 or not having LRN timed locks. In alternative adaptations, the routing requests 290 are and or may include session initiation protocol (SIP) requests 290, such those described in routing request header 292. The at least one processor 115 is configured communicate a 503 service-unavailable SIP reply to the SIP requests 290 having unexpired LRN timed locks 385, and to forward SIP requests 290 having expired or not having LRN timed locks.

Additionally, in alternative arrangements, the LRN timed lock 385 may be utilized by other components and devices of systems 100 to forward a limited amount of routing requests 290 to thereby throttle the bandwidth available to forward routing requests 290 having unexpired LRN time locks 385. As with the ANI timed locks 355, the bandwidth may be throttled or constrained to amounts between zero or no forwarding, and higher data rates as may be preferable.

In these variations, one or more of the at least one processors 115 communicate(s) with at least one LCR router 305 that is coupled to a routing database 340. The processors 115 are configured to receive the forwarded routing requests 290 and associated LRNs. The LCR router 305 is coupled to one or more LCR logic mappers 310, which are configured as already described. As explained elsewhere herein, in connection with other configurations of systems 100, the acceptable carrier routes in the generated LCR matrices are filtered to include only those routes for forwarding routing requests 290, wherein the pluralities of rates in the LCR matrix 367 generate greater than or equal to a minimum subscriber and or carrier gross profit amount per unit of time.

For example, the LCR logic mapper 310 filtering by use of the LCR matrix 367 to identify acceptable carrier routes, protects the supply side CPS-CS-bandwidth-limited, available routes of the carriers CR so that such limited bandwidth to include, and in turn forward, only the most desirable routing requests 290 and traffic T. This prevents the limited bandwidth infrastructure of the carriers CR from otherwise being inefficiently overwhelmed by lower quality routing requests 290 and traffic T.

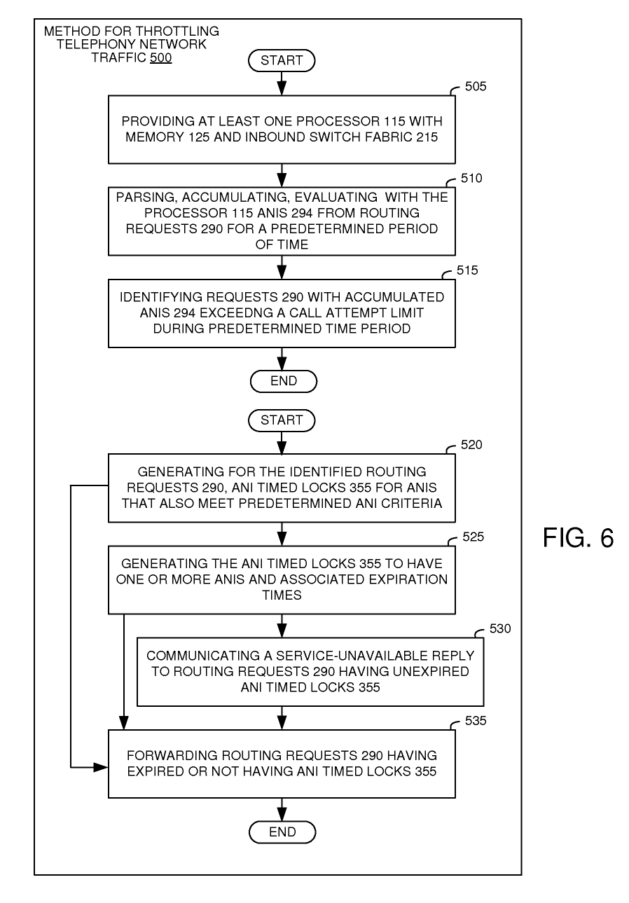

With continued reference to the various figures, and now also to FIGS. 4 and 6, another configuration of systems 100 contemplates a method of throttling telephony network traffic 500. Included in the method 500 are:

Step 505: providing at least one processor 115 having a memory 125 and in communication with an inbound switch fabric 215 and an external network IN.

Step 510: parsing with the processor 115 ANIs 296 from routing requests 290 received from the external network IN, and accumulating and evaluating ANIs 296 for a predetermined period of time.

Step 515: identifying routing requests 290 having accumulated ANIs 296 that exceed a call attempt limit during the predetermined period of time.

Step 520: generating for the identified routing requests, one or more ANI timed locks for those ANIs that also meet one or more predetermined ANI criteria.

Step 525: generating the one or more ANI timed locks, to have one or more ANIs and associated expiration times, and for those ANIs having one or more additional, predetermined criteria of (a) an ANI short duration percentage (SDP) above an ANI SDP limit, (b) an ANI answer seizure ratio (ASR) below an ANI ASR limit, and (c) an ANI average call duration (ACD) below an ANI ACD limit, which are some of the one or more predetermined ANI criteria.

Step 530: communicating a service-unavailable reply to routing requests having unexpired ANI timed locks.

Step 535: forwarding routing requests having expired or not having ANI timed locks.

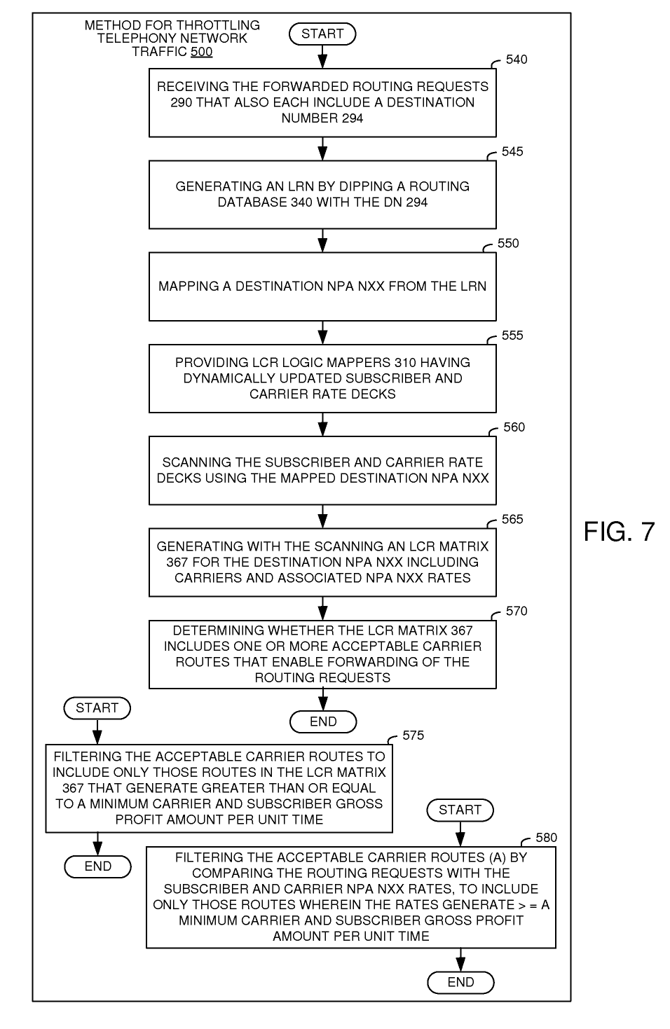

With reference now also to FIGS. 4 and 7, the method 500 also includes:

Step 540: receiving the forwarded routing requests that also each include a destination number DN 294.

Step 545: generating an LRN by dipping a routing database 340 with the DN 294.

Step 550: mapping a destination numbering plan areas/local number prefixes (NPA NXX) from the LRN.

Step 555: providing LCR logic mappers 310, configured with a plurality of dynamically updated subscriber and carrier rate decks each having a plurality of rates for respective NPAs NXXs.

Step 560: scanning the pluralities of rates for each of the subscriber and carrier rate decks of the plurality using the mapped destination NPA NXX.

Step 565: generating with the scanning an LCR matrix 367 for the destination NPA NXX including carriers and associated NPA NXX rates.

Step 570: determining whether the LCR matrix 367 includes one or more acceptable carrier routes exist that enable forwarding of the routing requests.

Step 575: filtering the acceptable carrier routes is accomplished to include only those routes wherein the pluralities of rates in the LCR matrix 367 generate greater than or equal to a minimum subscriber and or carrier gross profit amount per unit time to protect availability of CPS-CS-limited bandwidth acceptable carrier routes and prevent inefficient utilization.

Step 580: filtering the acceptable carrier routes (a) by comparing in real-time with the routing requests the dynamically updated pluralities of subscriber and carrier NPA NXX rates, and (b) to include only those routes wherein the pluralities of rates in the LCR matrix 367 generate greater than or equal to a minimum subscriber and or carrier gross profit amount per unit time.

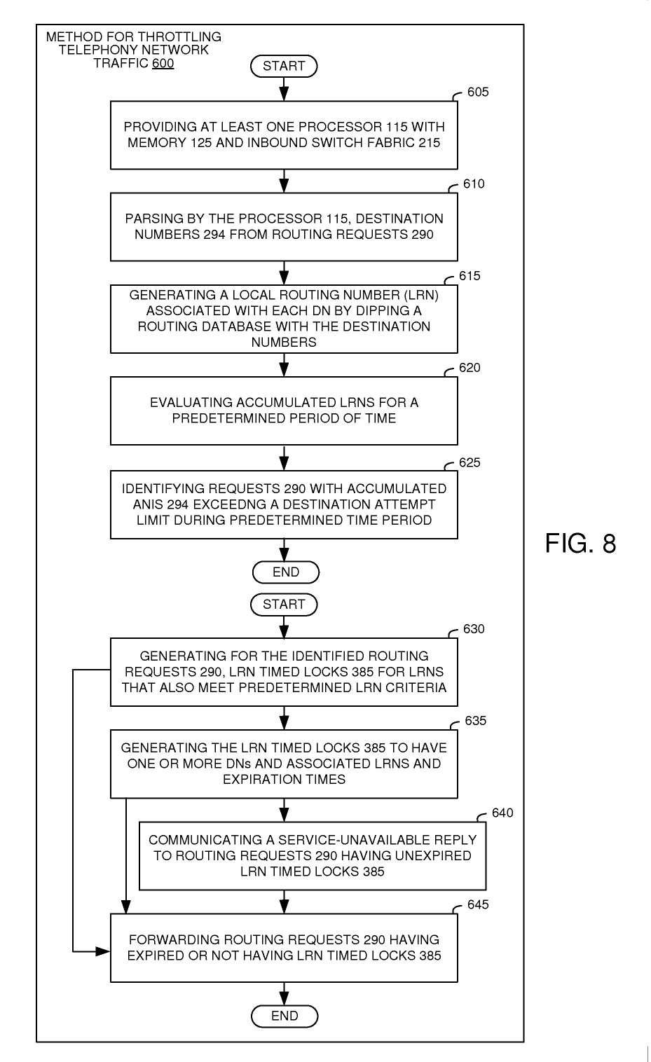

In another configuration, a method 600 of throttling telephony network traffic is illustrated in FIGS. 4 and 8, and includes:

Step 605: providing at least one processor having a memory and in communication with an inbound switch fabric and an external network.

Step 610: parsing by the at least one processor, destination numbers (DNs) from routing requests received from the external communications network.

Step 615: generating a local routing number (LRN) associated with each DN by dipping a routing database with the destination numbers.

Step 620: evaluating accumulated LRNs for a predetermined period of time.

Step 625: identifying routing requests having accumulated LRNs that exceed a destination attempt limit during the predetermined period of time.

Step 630: generating for the identified routing requests, one or more LRN timed locks 385 having LRNs that also meet one or more predetermined LRN criteria.

Step 635: generating the one or more LRN timed locks 385, to have one or more DNs and associated LRNs and expiration times, and for those LRNs having one or more of: (a) an LRN short duration percentage (SDP) above an LRN SDP limit, (b) an LRN answer seizure ratio (ASR) below an LRN ASR limit, and (c) an LRN average call duration (ACD) below an LRN ACD limit, which are some of the one or more predetermined LRN criteria. In other variations, the method step 635 is adapted for generating the one or more LRN timed locks 385 to have one or more DNs, and associated LRNs and expiration times.

Step 640: communicating a service-unavailable reply to routing requests having unexpired LRN timed locks 385.

Step 645: forwarding routing requests having expired or not having LRN timed locks.

In some configurations, the method steps 640 and 645 receive routing requests that are session initiation protocol (SIP) requests, and are configured for communicating a 503 service-unavailable SIP reply to SIP requests having unexpired LRN timed locks 385, and then for forwarding SIP requests having expired or not having LRN timed locks.

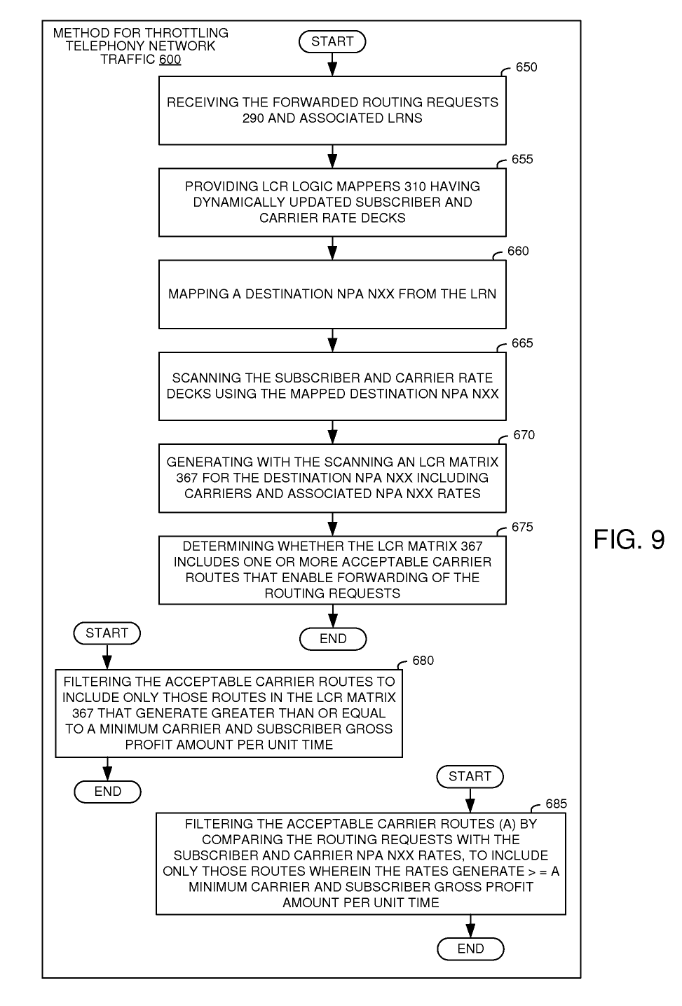

With reference now also to FIGS. 4 and 9, it can be understood that the method 600 also includes:

Step 650: receiving the forwarded routing requests and associated LRNs.

Step 655: providing one or more LCR logic mappers 310, configured with a plurality of dynamically updated subscriber and carrier rate decks each having a plurality of rates for respective numbering plan areas/local number prefixes (NPAs NXXs);

Step 660: mapping a destination NPA NXX from the LRN.

Step 665: scanning the pluralities of rates for each of the subscriber and carrier rate decks of the plurality using the mapped destination NPA NXX;

Step 670: generating with the scanning an LCR matrix 367 for the destination NPA NXX including carriers and associated NPA NXX rates.

Step 675: determining whether the LCR matrix 367 includes one or more acceptable carrier routes that enable forwarding of the routing requests.

Step 680: filtering the acceptable carrier routes to include only those routes in the LCR matrix 367 wherein the pluralities of rates in the LCR matrix generate greater than or equal to one or more of a minimum carrier and a minimum subscriber gross profit amount per unit time.

Step 685: filtering the acceptable carrier routes (a) by comparing in real-time with the routing requests the dynamically updated pluralities of subscriber and carrier NPA NXX rates, and (b) to include only those routes wherein the pluralities of rates in the LCR matrix 367 generate greater than or equal to one or more of a minimum carrier and a minimum subscriber gross profit amount per unit time. As noted elsewhere herein, Steps 680 and or 685 enable the systems 100 to protect availability of CPS-CS-limited-bandwidth acceptable carrier routes and prevent inefficient utilization by low quality traffic and routing requests 290.

With continued reference to the preceding figures, and with attention invited again FIG. 4, the telephony traffic network throttle and systems 100 and methods 500, 600 can be further described in an operational example. For purposes of illustration but not for limitation, a SIP and or HTTP host layer traffic session schematic is described in part, overlaid upon a logical and functional arrangement of portions of systems 100, and included parts of the methods 500, 600. During operation, the systems 100 receive at the inbound edge 200, inbound traffic T that includes a routing request 290.

In the human readable SIP or HTTP messaging context, the routing request 290 includes a SIP invite, similar to that described in the routing request header 292 of FIG. 3. The routing request 290 is received and inspected to ascertain whether it is from a source CL, S, C, that is authorized (“IP Auth?, FIG. 4) to utilize the systems 100. If the request 290 is not, an HTTP or SIP “403 Forbidden” reply may be sent, or the request 290 may be ignored. If utilization is authorized, then a reply “100 trying” may be sent indicating that the request 290 is being processed.

To ensure that the resources of system 100 are protected from less than desirable traffic, the routing request 290 is parsed for an ANI 296 and DN 294 (the DN 294 being dipped to generate an LRN) to ascertain whether it is from a source CL, C, S, that has been identified by either an ANI or LRN timed lock 355, 385. If so, then the routing request 290 may be subject to throttling of available bandwidth on the systems 100. Alternatively, the routing request 290 may be ignored if no bandwidth is to be allocated while the ANI, LRN timed lock 355, 385 remains unexpired.

If any ANI, LRN timed lock 355, 385 is expired or does not exist, then the routing request 290 is then evaluated, see FIG. 4 “ANI/LRN>Limit?”, to determine if the ANI and or LRN have accumulated during a look back period of time beyond a predetermined ANI call attempt limit and or a predetermined LRN destination attempt limit. For example, the ANI limiters 220 and the LRN limiters 275 may be configured to identify routing requests 290 for further evaluation, if more than 100 call or destination attempts have been made during the last 30 or 60 minutes, or any other desired time period or attempt limit. In this way, less than optimal network traffic T and routing requests 290 can be throttled to prevent inefficient utilization of systems 100.

If the call and or destination attempts exceed the predetermined limits, then the routing request 290 is further inspected whereby the ANIs and DNs previously accumulated are examined in more detail. The additional examination depicted in FIG. as “Criteria>Lim?” determines whether the identified ANIs and LRNs meet limits (ACD, ASR, SDP, etc.) of additional, predetermined criteria as previously described.

If the criteria limits are exceeded, then the ANI and or LRN timed locks 355, 385 are generated to throttle and or ignore routing requests 290 having the offending ANIs and or DNs/LRNs. By identifying and quickly throttling such routing requests at the inbound edge 200, the resources of systems 100 are conserved for desired network traffic T, which ensures efficient and optimal utilization. More specifically, the availability of resources of the systems 100 is protected from unwanted utilization. These protections are especially beneficial to operation of systems 100 when utilizing the CPS-CS-limited bandwidth of available, acceptable carrier routes.

Absent time locks 355, 385 and exceeded limits, the routing requests 290 shown in FIG. 4, are then forwarded internally for destination mapping, and LCR processing (310) to generate an LCR matrix 367 with the logic engines 365 to identify available routes R1, R2, through Rn (FIG. 4), and to determine if one or more acceptable routes exist for forwarding the routing request 290.

In other aspects of exemplary implementations of the telephony network traffic throttle 100 and traffic throttling methods 500, 600, the throttle and methods include a plurality of computer processors, transient memories and non-transient computer-readable storage media, network subsystems and interfaces, user interfaces and displays, switch fabric, and communications capabilities. These components and subsystems are or may be in part collocated, and are also configured in well-known geographically disparate, cloud-based arrangements that enable optimized and on-demand resource allocation, reliability, resilience, automated and near-instantaneous fail-over, and system-wide durability, using a variety of wide-available information technology architectures and implementations.

This summary of the implementations and configurations of the telephony network traffic throttle and traffic throttling methods is intended to introduce a selection of exemplary implementations, configurations, and arrangements, in a simplified and less technically detailed arrangement, and such are further described in more detail below in the detailed description. This summary is not intended to identify key features or essential features of the claimed technology, nor is it intended to be used as an aid in determining the scope of the claimed subject matter. The features, functions, capabilities, and advantages discussed here may be achieved independently in various example implementations or may be combined in yet other example implementations, as further described elsewhere herein, and which may also be better understood by those skilled and knowledgeable in the relevant fields of technology, with reference to the following description and drawings.

The above description refers to systems, methods, components, elements, nodes, or features being in “communication” together. As used herein, unless expressly stated otherwise, use of these terms and words must be understood to mean that one system/method/component/element/node/module/feature is directly or indirectly coupled, joined to, and/or communicates with another, either electronically, mechanically, or both and in some similar way that enables cooperative operation. Further, even though the various described implementations, figures, illustrations, and drawings depict representative examples and arrangements of components, elements, devices, and features, many different additional variations, arrangements, modifications, and intervening components, elements, devices, and features, may also be present in further exemplary implementations that are contemplated by the present disclosure.

Terms, words, and phrases used in this document, and variations thereof, unless otherwise expressly stated, must be construed as open ended as opposed to limiting. For example, the term “including” should be understood to mean “including, without limitation” or similar meanings; the term “example” is used to loosely describe illustrative instances of the item being described, but is not an exhaustive, exclusive, or limiting list; and adjectives such as “conventional,” “traditional,” “normal,” “standard,” “known”, and terms with similar meanings must not be construed to limit the description to a given example, time period, or to an exemplary item commercially available in the market as of a specific date and time period.

Instead, these descriptions are intended to be understood to include conventional, traditional, normal, or standard technologies that may be available now and at any time in the future in some improved and modified form. Similarly, a group of words described and joined with the conjunction “and” or the disjunctive “or” must be understood only as exemplary and representative but not exclusive groups, and not as requiring that only or each and every one of those described items must be or must not be present in the contemplated group. Rather, use of such conjunctives and disjunctives must be understood to mean “and/or” unless expressly stated otherwise.

Similarly, a group of words linked with the conjunction “or” must not be understood as requiring mutual exclusivity among that group, but rather must also be understood as meaning “and/or” unless expressly stated otherwise. Also, although words, items, elements, or components of this disclosure are described or claimed in the singular, the plural is also intended and contemplated to be within the scope of such a description unless limitation to the singular is explicitly stated as a requirement. The presence or absence of broadening words and phrases such as “one or more,” “at least,” “but not limited to” or other like phrases in some instances are intended to be interpreted to contemplate broader meanings, but must not be understood to mean that narrower meanings are implied, intended, or required.

1. A telephony network traffic throttle, comprising:
at least one processor coupled to a memory and in communication with a switch fabric, and configured to receive routing requests via the switch fabric and to parse and communicate automatic number identifications (ANIs) from the routing requests; and
an ANI limiter coupled to the at least one processor, configured to evaluate accumulated ANIs for a predetermined period of time and to identify routing requests having accumulated ANIs that exceed a call attempt limit during the predetermined period of time.

2. The telephony network traffic throttle according to claim 1, further comprising:
the ANI limiter configured to generate one or more ANI timed locks for the identified routing requests having ANIs that also meet one or more predetermined ANI criteria.

3. The telephony network traffic throttle according to claim 2, further comprising:
the ANI limiter configured to generate the one or more ANI timed locks for those ANIs having one or more of (a) an ANI short duration percentage (SDP) above an ANI SDP limit, (b) an ANI answer seizure ratio (ASR) below an ANI ASR limit, and (c) an ANI average call duration (ACD) below an ANI ACD limit, wherein criteria (a), (b), and (c) are some of the one or more predetermined ANI criteria.

4. The telephony network traffic throttle according to claim 2, further comprising:
the ANI limiter configured to generate one or more of the ANI timed locks to have one or more ANIs and associated expiration times.

5. The telephony network traffic throttle according to claim 4, further comprising:
the at least one processor is configured to forward routing requests having expired or not having ANI timed locks.

6. The telephony network traffic throttle according to claim 5, further comprising:
at least one least cost router (LCR router) in communication with a dynamic routing database, and configured to receive the forwarded routing requests that also each include a destination number;
the at least one LCR router is configured to dip the dynamic routing database to generate a local routing number (LRN) associated with the destination number;
one or more LCR logic mappers coupled to the at least one LCR router and configured with a plurality of dynamically updated subscriber and carrier rate decks each having a plurality of rates for respective numbering plan areas/local number prefixes (NPAs NXXs);
wherein the LCR logic mappers are configured to: (a) map a destination NPA NXX from the LRN, (b) scan the pluralities of rates for each of the subscriber and carrier rate decks of the plurality, using the mapped destination NPA NXX to identify available carriers, and (c) generate with the scan an LCR matrix for the destination NPA NXX including associated subscriber and carrier NPA NXX rates; and
wherein the LCR router receives the LCR matrix and determines whether one or more acceptable carrier routes exist that enable forwarding of the routing request.

7. The telephony network traffic throttle according to claim 6, further comprising:
the one or more acceptable carrier routes are filtered to include only those routes wherein the pluralities of rates in the LCR matrix generate greater than or equal to one or more of a minimum carrier and a minimum subscriber gross profit amount per unit of time.

8. The telephony network traffic throttle according to claim 7, further comprising:
the one or more acceptable carrier routes are filtered, (a) by comparing in real-time with the routing requests the dynamically updated pluralities of subscriber and carrier NPA NXX rates, (b) to include only those routes wherein the pluralities of rates in the LCR matrix generate greater than or equal to one or more of a minimum carrier and a minimum subscriber gross profit amount per unit of time.

9. A telephony network traffic throttle, comprising:
at least one processor coupled to a memory and in communication with a routing database, and configured to receive routing requests and to parse and communicate destination numbers (DNs) from the routing requests;
the at least one processor configured to use the DNs to dip the routing database to generate a local routing number (LRN) associated with each DN; and
an LRN limiter coupled to the at least one processor, and configured to evaluate accumulated LRNs for a predetermined period of time and to identify routing requests having accumulated LRNs that exceed a destination attempt limit during the predetermined period of time.

10. The telephony network traffic throttle according to claim 9, further comprising:
the LRN limiter configured to generate one or more LRN timed locks for the identified routing requests having LRNs that also meet one or more predetermined LRN criteria.

11. The telephony network traffic throttle according to claim 10, further comprising:
the LRN limiter configured to generate the one or more LRN timed locks for those LRNs having one or more of (a) an LRN short duration percentage (SDP) above an LRN SDP limit, (b) an LRN answer seizure ratio (ASR) below an LRN ASR limit, and (c) an LRN average call duration (ACD) below an LRN ACD limit, wherein criteria (a), (b), and (c) are some of the one or more predetermined LRN criteria.

12. The telephony network traffic throttle according to claim 10, further comprising:
the LRN limiter configured to generate one or more of the LRN timed locks to have one or more DNs, and associated LRNs and expiration times.

13. The telephony network traffic throttle according to claim 12, further comprising:
the at least one processor is configured to forward routing requests having expired or not having LRN timed locks.

14. The telephony network traffic throttle according to claim 13, further comprising:
at least one least cost router (LCR router) in communication with a routing database, and configured to receive the forwarded routing requests and associated LRNs;
the at least one LCR router coupled to one or more LCR logic mappers configured with a plurality of dynamically updated subscriber and carrier rate decks each having a plurality of rates for respective numbering plan areas/local number prefixes (NPAs NXXs);
wherein the LCR logic mappers are configured to: (a) map a destination NPA NXX from the LRN, (b) scan the pluralities of rates for each of the subscriber and carrier rate decks of the plurality, using the mapped destination NPA NXX to identify available carriers, and (c) generate with the scan an LCR matrix for the destination NPA NXX including associated subscriber and carrier NPA NXX rates; and
wherein the LCR router receives the LCR matrix and determines whether one or more acceptable carrier routes exist that enable forwarding of the routing request.

15. The telephony network traffic throttle according to claim 14, further comprising:
the acceptable carrier routes are filtered to include only those routes wherein the pluralities of rates in the LCR matrix generate greater than or equal to one or more of a minimum carrier and a minimum subscriber gross profit amount per unit of time.

16. A method of throttling telephony network traffic, comprising:
providing at least one processor having a memory and in communication with an inbound switch fabric and an external network;
parsing by the at least one processor, automatic number identifications (ANIs) from routing requests received from the external network;
evaluating accumulated ANIs for a predetermined period of time; and
identifying routing requests having accumulated ANIs that exceed a call attempt limit during the predetermined period of time.

17. The method according to claim 16, further comprising:
generating for the identified routing requests, one or more ANI timed locks for those ANIs that also meet one or more predetermined ANI criteria.

18. The method according to claim 17, further comprising:
generating the one or more ANI timed locks, to have one or more ANIs and associated expiration times, and for those ANIs having one or more of (a) an ANI short duration percentage (SDP) above an ANI SDP limit, (b) an ANI answer seizure ratio (ASR) below an ANI ASR limit, and (c) an ANI average call duration (ACD) below an ANI ACD limit, which are some of the one or more predetermined ANI criteria.

19. The method according to claim 17, further comprising:
generating the one or more ANI timed locks to have one or more ANIs, and associated expiration times.

20. The method according to claim 19, further comprising:
forwarding routing requests having expired or not having ANI timed locks.

21. The method according to claim 20, further comprising:
receiving the forwarded routing requests that also each include a destination number;
generating a local routing number (LRN) associated with the destination number by using the destination number to dip a routing database;
mapping a destination numbering plan areas/local number prefixes (NPAs/NXXs) from the LRN;
providing one or more LCR logic mappers, and configured with a plurality of dynamically updated subscriber and carrier rate decks each having a plurality of rates for respective NPAs NXXs;
scanning the pluralities of rates for each of the subscriber and carrier rate decks of the plurality using the mapped destination NPA NXX;
generating with the scanning an LCR matrix for the destination NPA NXX including carriers and associated NPA NXX rates; and
determining whether the LCR matrix includes one or more acceptable carrier routes that enable forwarding of the routing requests.

22. The method according to claim 21, further comprising:
filtering the acceptable carrier routes to include only those routes wherein the pluralities of rates in the LCR matrix generate greater than or equal to one or more of a minimum carrier and a minimum subscriber gross profit amount per unit time.

23. The method according to claim 21, further comprising:
filtering the acceptable carrier routes (a) by comparing in real-time with the routing requests the dynamically updated pluralities of subscriber and carrier NPA NXX rates, (b) to include only those routes wherein the pluralities of rates in the LCR matrix generate greater than or equal to one or more of a minimum carrier and a minimum subscriber gross profit amount per unit time.

24. A method of throttling telephony network traffic, comprising:
providing at least one processor having a memory and in communication with an inbound switch fabric and an external network;
parsing by the at least one processor, destination numbers (DNs) from routing requests received from the external network;
generating a local routing number (LRN) associated with each DN by dipping a routing database with the destination numbers; and
evaluating accumulated LRNs for a predetermined period of time; and
identifying routing requests having accumulated LRNs that exceed a destination attempt limit during the predetermined period of time.

25. The method according to claim 24, further comprising:
generating for the identified routing requests, one or more LRN timed locks having LRNs that also meet one or more predetermined LRN criteria.

26. The method according to claim 25, further comprising:
generating the one or more LRN timed locks, to have one or more DNs and associated LRNs and expiration times, and for those LRNs having one or more of: (a) an LRN short duration percentage (SDP) above an LRN SDP limit, (b) an LRN answer seizure ratio (ASR) below an LRN ASR limit, and (c) an LRN average call duration (ACD) below an LRN ACD limit, which are some of the one or more predetermined LRN criteria.

27. The method according to claim 25, further comprising:
generating the one or more LRN timed locks to have one or more DNs, and associated LRNs and expiration times.

28. The method according to claim 27, further comprising:
forwarding routing requests having expired or not having LRN timed locks.

29. The method according to claim 28, further comprising:
receiving the forwarded routing requests and associated LRNs;
providing one or more LCR logic mappers, and configured with a plurality of dynamically updated subscriber and carrier rate decks each having a plurality of rates for respective numbering plan areas/local number prefixes (NPAs NXXs);
mapping a destination NPA NXX from the LRN;
scanning the pluralities of rates for each of the subscriber and carrier rate decks of the plurality using the mapped destination NPA NXX;
generating with the scanning an LCR matrix for the destination NPA NXX including carriers and associated NPA NXX rates; and
determining whether the LCR matrix includes one or more acceptable carrier routes that enable forwarding of the routing requests.

30. The method according to claim 29, further comprising:
filtering the acceptable carrier routes to include only those routes wherein the pluralities of rates in the LCR matrix generate greater than or equal to one or more of a minimum carrier and a minimum subscriber gross profit amount per unit time.
